(19) United States
(12) Patent Application Publication
(10) Pub. No.: US 2017/0250626 A1
(43) Pub. Date: Aug. 31, 2017

(54) Energy System with C02 Extraction

(71) Applicant: StarGreen Power Corporation, Calgary (CA)

(72) Inventor: Jean Barlot, Calgary (CA)

(21) Appl. No.: 15/512,255

(22) PCT Filed: Sep. 16, 2015
(86) PCT No.: PCT/CA2015/050904

§ 371 Date: Mar. 17, 2017

Related U.S. Application Data
(60) Provisional application No. 62/121,962, filed on Feb. 27, 2015.
(60) Provisional application No. 62/056,839, filed on Sep. 29, 2014.

(51) Int. Cl. H02N 2/18; B01D 53/14; F03D 1/04

(52) U.S. Cl. CPC H02N 2/18; F03D 1/04; B01D 53/1475; B01D 53/14; B01D 53/1456; F03D 9/255

(57) ABSTRACT

An auxiliary wind energy device comprising a valve device embodied as a rotating aperture plate located adjacent a fixed aperture plate to cyclically operate between open and closed positions to produce intermittent flow at the inlet of the housing and piezoelectric oscillator blades subject to said intermittent flow bending forwardly and backwardly to generate electrical current.

### FIELD OF THE INVENTION

The present invention relates to wind energy systems for conversion of wind energy into electricity for commercial distribution by using large wind funnels located within structures to accelerate wind to a turbine and generator, and more particularly the present invention relates to a wind energy system which includes use of carbon dioxide absorbing material for CO2 extraction.

### BACKGROUND

In the field of generating commercial scale electricity by using wind energy to turn a turbine, most typical installations use large open rotor blade devices elevated high up on towers which by the nature of their design have certain issues that compromise their overall effectiveness. Their open rotor blades are vulnerable to destructive wind gusts and being elevated on towers makes them difficult to service and repair. They are also noisy, hazardous to birds, they create vibrations harmful to animals, and for many people they are generally regarded as unsightly. In terms of energy production open air rotor blades are largely inefficient in capturing and converting wind energy to electricity and they require high winds in order to function which are then only found in select areas often remote from the power grid.

### SUMMARY OF THE INVENTION

It is one object to the present invention to provide a system which captures wind energy in a manner which overcomes some of the problems associated with elevated open rotor blade devices.

More particularly, the invention relates to the generation of electricity from wind using large scale wind funnels located within structures, to increase the wind's speed and power to efficiently turn a turbine and generator at high speeds to produce electricity for commercial distribution, for example in the range of three to six megawatts and more for one average sized structure.

The invention can operate at low minimum wind speeds, for example only five to ten kilometres per hour, which can be found in many locations for long spans of time. Optimally the invention will be located in close proximity to the existing power grid to reduce transmission lines.

The wind funnel structures can be made in a variety of forms and can be situated in many locations. Where the invention is located on land the preferred embodiments will simulate the appearance of a building such as a house, barn, or other building forms. Where the invention is located on a float on water the preferred embodiments will simulate the appearance of a yacht. In these ways the preferred embodiments can aesthetically integrate with the local environment and be an acceptable element to people where the invention is located.

Where the invention is located on a float on water, a stabilizing system of cables and ballasts is used.

The single direction wind funnel system intakes wind from a single direction into a large funnel of decreasing cross sectional area that increases the wind's speed and power to efficiently turn a turbine and generator in conjunction with a shroud. A sound attenuation module located after the shroud mitigates any noise.

The retractable multiple direction wind funnel system can intake wind from any of four directions into direction specific wind funnels of decreasing cross sectional area which increases the wind's speed and power to efficiently turn a turbine and generator in conjunction with a shroud, and without need for the invention to be rotated to incoming wind directions. Four direction specific wind funnels are created through specific arrangements of retractable partitions activated by electric sensors and powered by electric motors or a pneumatic air system.

The fixed multiple direction wind funnel system is similar to the retractable multiple direction wind funnel system but with the exception that by the nature of its form most of its wind funnels are fixed in place to receive wind individually from any of four directions and uses only a few retractable partitions to separate the wind funnels from each other. The preferred embodiment has four direction specific wind funnels but more are also possible.

All embodiments use a shroud after the turbine and generator and wind funnel to increase wind speed and power. Two embodiments use a piezoelectric oscillator module which may simulate the appearance of a house, barn, or other building form wherein wind oscillates piezoelectric oscillator blades to create electricity while also acting as sound attenuation.

The invention in its preferred embodiments is quiet, efficient, serviceable, bird friendly, easily locatable, and can make an agreeable element in the landscape by aesthetically integrating with its surroundings in the form of a house, barn, or other building form.

Excess energy produced by the invention can be stored in batteries, compressed air containers, or be stored and distributed by a new dedicated electric line on the existing power grid. This new electric line would be energized by a network of green energy producing installations over a variety of locations and form what could be called a new “Green Energy Grid”, or which may have another name.

According to one aspect of the invention there is provided a wind turbine assembly comprising:

a main housing including a plurality of upright wall portions, a roof portion, and at least one inlet opening formed in the upright wall portions;

a wind turbine supported within the housing which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct; and

inlet ducting communicating from said at least one inlet opening to the turbine inlet;

the upright wall portions, the roof portion, and said at least one inlet opening of the housing being configured to visually represent a building.

In some embodiments the turbine assembly is supported on a foundation substantially at ground level.

Preferably a screen spans across said at least one inlet opening so as to be substantially flush with the respective wall portion.

Preferably a plurality of inlet openings are located in respective upright wall portions on different sides of the housing. More preferably, when the upright wall portions define a rectangular perimeter of the housing having four sides, there is provided an inlet opening in each of the four sides of the housing.

The inlet ducting preferably includes a funnel shaped inlet duct arranged for communication between each inlet opening and the turbine inlet, each inlet duct comprising at least one movable boundary wall partition which is movable (for example by being retractable) between an operable position forming a portion of a boundary of the respective inlet duct which obstructs communication of at least one other inlet duct with the turbine inlet and a stored position in which communication of said at least one other inlet duct is substantially unobstructed by the movable boundary wall partition.

Preferably at least one movable boundary wall partition is associated with each inlet opening so as to be movable between a closed (or deployed) position spanning across the inlet opening such that the inlet opening is closed, inactive and out-of-use and an open position in which the inlet opening is substantially unobstructed by the movable boundary wall partition. More particularly, each inlet opening may include a plurality of boundary wall partitions associated therewith in which each boundary wall partition spans only a respective portion of the overall inlet opening in the closed position thereof while the respective portion of the overall inlet opening remains unobstructed in the open position thereof. In this instance, the wall partitions of each inlet opening may be operated in a partially opened condition of the overall inlet opening in which some of the wall partitions are opened and some are closed. For example, two inlet openings on adjacent sides of a housing may each be partially opened when the wind is directed onto both of said adjacent sides of the housing at an oblique angle thereto.

The assembly may further comprise a wind sensor arranged to sense wind speed through each inlet opening and a controller arranged to controllably position said at least one movable wall portion of the respective inlet opening in one or more intermediate positions so as to regulate the flow or quantity of wind through the respective inlet opening within a prescribed operating range of a wind speeds.

Preferably a bottom boundary wall of all of the inlet ducting is sloped downwardly towards said at least one inlet opening.

Preferably there is provided a secondary housing separate from the main housing and exhaust ducting communicating from the turbine outlet to the secondary housing. The secondary housing preferably includes sound attenuating structures therein. The exhaust ducting may comprise a shroud which diverges and expands in cross sectional area from the turbine towards the secondary housing.

Preferably the sound attenuating structure comprises an exhaust duct in the secondary housing which follows a sinuous path from an inlet end in communication with the exhaust ducting to an outlet end which is exhausted externally of the secondary housing.

Preferably the exhaust duct in the secondary housing comprises an absorbing material suited for carbon dioxide absorption from a flow of exhaust air communicated or transmitted through the exhaust ducting from the inlet end to the outlet end.

The assembly may further comprise an auxiliary wind energy device supported within the secondary housing. In this instance, the secondary housing preferably includes walls surrounding a hollow interior extending in a longitudinal direction between an inlet at a first end and an outlet at a second end of the housing and the auxiliary wind energy device preferably further comprises:

a valve device cooperative with the inlet of the housing so as to be cyclically operable between an open position permitting a prescribed wind flow through in the inlet into the housing and a closed position in which wind flow through the inlet into the housing is at least partially restricted relative to the open position so as to generate an intermittent flow of wind through the housing;

at least one oscillating blade member supported in the hollow interior of the housing so as to extend transversely to the longitudinal direction of the housing between a first end coupled to the housing and a second end which is freely suspended within the hollow interior, said at least one oscillating blade member comprising:
a main body which is flexible in a direction corresponding to the second end of the oscillating blade member being movable generally in the longitudinal direction of the housing such that the main body is arranged to oscillate in respective to said intermittent flow; and
piezoelectric material coupled to the main body so as to be subjected to bending stresses of the main body so as to create an electrical current in response to oscillations of the main body.

According to a second aspect of the present invention there is provided a wind turbine assembly comprising:

a main housing including a plurality of upright wall portions a plurality of inlet openings located in respective upright wall portions on different sides of the housing;

a wind turbine supported within the housing which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct; and

an inlet duct arranged for communication between each inlet opening and the turbine inlet;

wherein each inlet duct comprises at least one movable boundary wall partition which is movable between an operable position forming a portion of a boundary of the respective inlet duct which obstructs communication of at least one other inlet duct with the turbine inlet and a stored position in which communication of said at least one other inlet duct is substantially unobstructed by the movable boundary wall partition.

Preferably a bottom boundary wall of each inlet duct is sloped downwardly towards the respective inlet opening.

Preferably the inlet openings are provided in at least two of the upright wall portions of the main housing which are different in orientation from one another so as to span a majority of the wall portion.

When the upright wall portions of the housing define a polygonal shape having numerous sides, preferably one of the inlet openings is provided in each of the sides of the polygonal shape of the housing so as to span a majority of the respective side.

Preferably at least one movable boundary wall partition associated with each inlet opening is movable between a closed position spanning across the inlet opening such that the inlet opening is inoperable and closed and an open position in which the inlet opening is substantially unobstructed by the movable boundary wall partition.

Each movable boundary wall partition may comprise a flexible member coupled to a roller so as to be arranged to be rolled onto the roller when not in use.

Preferably each roller is supported outside of a boundary of the respective inlet duct such that the flexible member is arranged to be deployed from the roller into the inlet duct through a dispensing slot in a top boundary wall of the respective inlet duct.

Preferably the flexible member comprises a flexible sheet member and a plurality of rigid slats spanning a width of the sheet member spaced apart from one another and substantially parallel to an axis of the respective roller such that the rigid slats are angularly adjustable relative to one another within a plane of the boundary wall partition.

Preferably a plurality of structural cables are arranged to be supported under tension to span between opposing boundaries of respective inlet ducts so as to support the movable boundary wall partitions respectively when in use.

When each inlet duct comprises side boundaries, in some embodiments, the majority of the side boundaries are defined by fixed boundary wall partitions.

Alternatively, in other embodiments, a majority of the side boundaries are defined by the movable boundary wall partitions. In this instance a portion of each side boundary of each inlet duct is defined by a plurality of the movable boundary wall partitions in series with one another in which the movable boundary wall partitions are planar in use and angularly offset from adjacent ones of the movable boundary wall partitions such that the side boundary is generally curved.

Preferably a pressure relief duct is provided in communication with each inlet duct in which each pressure relief duct is arranged to be exhausted externally of the main housing only when a pressure within the inlet duct exceeds an upper pressure relief limit.

According to another aspect of the present invention there is provided a wind energy device comprising:

a housing including boundary walls surrounding a hollow interior extending in a longitudinal direction between an inlet at a first end and an outlet at a second end of the housing;

a valve device cooperative with the inlet of the housing so as to be cyclically operable between an open position permitting a prescribed wind flow through in the inlet into the housing and a closed position in which wind flow through the inlet into the housing is at least partially restricted relative to the open position so as to generate an intermittent flow through the housing;

at least one oscillating blade member supported in the hollow interior of the housing so as to extend transversely to the longitudinal direction of the housing between a first end coupled to the housing and a second end which is freely suspended within the hollow interior, said at least one oscillating blade member comprising:
a main body which is flexible in a direction corresponding to the second end of the oscillating blade member being movable generally in the longitudinal direction of the housing such that the main body is arranged to oscillate in respective to said intermittent flow; and
piezoelectric material coupled to the main body so as to be subjected to bending stresses of the main body so as to create an electrical current in response to oscillations of the main body.

Preferably said at least one oscillating blade member is part of a plurality of oscillating blade members at laterally and longitudinally spaced positions throughout the hollow interior of the housing.

Preferably the oscillating blade members are arranged in laterally oriented rows which are longitudinally spaced apart such that each oscillating blade member is laterally offset relative to the oscillating blade members of adjacent rows.

When provided in combination with a wind turbine comprising a turbine duct communicating from a turbine inlet to a turbine outlet and a turbine rotor which is rotatable within the turbine duct and which is arranged to be driven to rotate in response to a flow of air through the turbine duct, preferably the turbine outlet is operatively connected to the inlet of the housing such that the valve device is in series between the turbine and the housing.

The valve device may comprise a fixed member having at least one fixed aperture therein and a rotating member supported for rotation relative to the fixed member and having at least one rotating aperture therein arranged to be cyclically aligned with said at least one fixed aperture as the rotating member is rotated relative to the fixed member.

Preferably the rotating member includes at least one blade supported therein so as to be arranged to drive rotation of the rotating member in response to a flow of wind therethrough.

In the illustrated embodiments, said at least one fixed aperture comprises a pair of fixed apertures which are diametrically opposed relative to one another about an axis of the rotating member and said at least one rotating aperture comprises a pair of rotating apertures which are diametrically opposed relative to one another about said axis of the rotating member.

According to another aspect of the present invention there is provided a wind turbine assembly comprising:

a buoyant housing arranged to be buoyantly supported on a body of water;

a wind turbine supported on the housing above a surface of the body of water which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct;

a plurality of anchoring cables, each extending between a first end coupled to the frame and a second end arranged to be coupled to a fixed structure (for example an anchor on the sea bed); and

a biasing element coupled to each cable so as to bias the cable away from a first position in which the first and second ends of the cable are at a first prescribed distance relative to one another towards at least one second position in which the first and second ends of the cable are at a second prescribed distance relative to one another which is less than the first prescribed distance.

The buoyant housing preferably comprises a plurality of upright wall portions and a roof portion which surround the wind turbine and which are configured to resemble a marine vessel.

Preferably the biasing element comprises a weighted ballast member supported on each cable at an intermediate location spaced inwardly from both of the first and second ends of the respective cable.

Preferably the cables extend radially outwardly from the buoyant housing at circumferentially spaced apart positions about a full perimeter of the buoyant housing from the first ends to the second ends of the cables.

Preferably the second ends of the cable are coupled to respective ballast members arranged to be fixed relative to the sea bed of the body of water.

According to another aspect of the present invention there is provided an auxiliary electrical grid for use in combination with an existing electrical grid comprised of a network of primary transmission cables communicating from a source to a plurality of users and a plurality of green energy devices arranged to generate electricity without consuming fuel, the auxiliary electrical grid comprising:

a network of auxiliary transmission cables in communication between the green energy devices and the plurality of users in parallel with the existing electrical grid.

Preferably the green energy devices are the only source of electrical energy supplied to the auxiliary grid.

Preferably the auxiliary electrical grid is arranged to provide supplementary electrical power to the existing electrical grid.

According to another aspect of the present invention there is provided a wind turbine assembly comprising:

a wind turbine including a turbine duct communicating from a turbine inlet to a turbine outlet, and a turbine rotor which is rotatable within the turbine duct and which is arranged to be driven to rotate in response to a flow of air through the turbine duct;

an inlet duct having boundary walls defining an inlet passage communicating between an inlet opening of the inlet duct arranged to receive a flow of wind therein and the turbine inlet;

an auxiliary supply fan communicating through one of the boundary walls of the inlet duct between the inlet opening and the turbine inlet so as to be arranged to supply an auxiliary flow of air to the inlet duct; and

a gate operable between an open position in which the inlet opening is substantially unobstructed by the gate and a closed position in which the inlet opening is closed by the gate.

Preferably the assembly further comprises a sensor arranged to sense a low air flow condition such that when the airflow through the duct is below a minimum threshold, the duct inlet and portions of the gate close and the auxiliary supply fan operates responsive to determination of a low air flow condition.

When an electrical generator is driven by the turbine rotor, preferably the auxiliary supply fan is driven to rotate using an electrical motor operatively connected to receive electrical power from the electrical generator.

Preferably the assembly further comprises a flywheel mass driven to rotate together with the turbine.

When the inlet duct is funnel shaped so as to be reduced in cross section from the inlet opening to the turbine inlet, preferably the auxiliary supply fan communicates with the inlet duct proximate to the inlet opening.

Various embodiments of the invention will now be described in conjunction with the accompanying drawings in which:

### BRIEF DESCRIPTION OF THE DRAWINGS

FIG. 1 is the floor plan of a building simulating the appearance of a house with a single direction wind funnel system 1 connected to a turbine 7, generator 8, optional secondary turbine rotor 9, shroud 10, and sound attenuation module 11;

FIG. 2 is a longitudinal section through the single direction wind funnel system 1 as per FIG. 1;

FIG. 3 is a cross section through the single direction wind funnel system 1 taken near the entrance to the wind funnel 6;

FIG. 4 is a cross section through the single direction wind funnel system 1 taken near the turbine 7;

FIG. 5 is the roof plan of the single direction wind funnel system 1 showing the pressure release dormers 16 shroud 10 and sound attenuation module 11;

FIG. 6 is the front elevation of the single direction wind funnel system 1 showing the inlet or wind intake aperture 17 and other components as indicated;

FIG. 7 is the left side elevation of the single direction wind funnel system 1 showing the wind intake aperture 17 and other components as indicated;

FIG. 8 is the back elevation of the single direction wind funnel system 1 showing the wind intake aperture 17 and other components as indicated;

FIG. 9 is the right side elevation of the single direction wind funnel system 1 showing the wind intake aperture 17 and other components as indicated;

FIG. 10 illustrates a method to elevate the invention by raising the existing grade 19 to a new elevated grade 20 where the invention is located on flat land simply by moving earth and using foundation piles 21 to the depth of undisturbed soil thereby eliminating the need for soil compaction;

FIG. 11 is the plan of the retractable multiple direction wind funnel system 22 showing the arrangement of the four wind funnels with the front wind funnel 6 in activated position leading to the turbine 7, generator 8, optional secondary turbine rotor 9, shroud 10, and sound attenuation module 11;

FIG. 12 is the plan of the retractable multiple direction wind funnel system 22 showing the arrangement of the four wind funnels with the right side wind funnel 6 in activated position leading to the turbine 7, generator 8, optional secondary turbine rotor 9, shroud 10, and sound attenuation module 11;

FIG. 13 is the plan of the retractable multiple direction wind funnel system 22 showing the arrangement of the four wind funnels with the left side wind funnel 6 in activated position leading to the turbine 7, generator 8, optional secondary turbine rotor 9, shroud 10, and sound attenuation module 11;

FIG. 14 is the plan of the retractable multiple direction wind funnel system 22 showing the arrangement of the four wind funnels with the back wind funnel 6 in activated position leading to the turbine 7, generator 8, optional secondary turbine rotor 9, shroud 10, and sound attenuation module 11;

FIG. 15 is a cross section through the retractable multiple direction wind funnel system 22 with the front wind funnel 6 in activated position;

FIG. 16 is a longitudinal section through the retractable multiple direction wind funnel system 22 with the front wind funnel 6 in activated position leading to the turbine 7, generator 8, optional secondary turbine rotor 9, shroud 10, and sound attenuation module 11;

FIG. 17 is a cross section through the retractable multiple direction wind funnel system 22 with the back wind funnel 6 in activated position leading to the turbine 7, generator 8, optional secondary turbine rotor 9, shroud 10, and sound attenuation module 11;

FIG. 18 is a cross section through the retractable multiple direction wind funnel system 22 with the left side wind funnel 6 in activated position leading to the turbine 7, generator 8, optional secondary turbine rotor 9, shroud 10, and sound attenuation module 11;

FIG. 19 is the front elevation of the retractable multiple direction wind funnel system 22 showing the wind intake aperture 17 where wind enters through the metal bird screen 3 and retractable partitions 4;

FIG. 20 is the left side elevation of the retractable multiple direction wind funnel system 22 showing the wind intake aperture 17 where wind enters through the metal bird screen 3 and retractable partitions 4;

FIG. 21 is the back elevation of the retractable multiple direction wind funnel system 22 showing the wind intake aperture 17 where wind enters through the metal bird screen 3 and retractable partitions 4;

FIG. 22 is the right side elevation of the retractable multiple direction wind funnel system 22 showing the wind intake aperture 17 where wind enters through the metal bird screen 3 and retractable partitions 4;

FIG. 23 is a plan of retractable partitions 4 between tensioned cables with guides 5 which are arranged to form a straight segment;

FIG. 23A is a section through the retractable partitions 4 as per FIG. 23;

FIG. 23B is an elevation of the retractable partitions 4 as per FIG. 23;

FIG. 24 is a plan of retractable partitions 4 between tensioned cables with guides 5 which are arranged to form a curved segment;

FIG. 24A is a section through the retractable partitions 4 as per FIG. 24;

FIG. 24B is an elevation of the retractable partitions 4 as per FIG. 24;

FIG. 25 is a plan of retractable partitions 4 between tensioned cables with guides 5 which adapt for a sloping floor area of the wind funnel 6;

FIG. 25A is a section through the retractable partitions 4 as per FIG. 25;

FIG. 25B is an elevation of the retractable partitions 4 as per FIG. 25;

FIG. 26 is an elevation detail of the retractable partition 4 in the deployed position illustrating the metal slats with air tight fabric affixed adapting to a sloping floor area of the wind funnel 6;

FIG. 27 is a plan detail of the cables with guides 5 of the retractable partitions 4 showing a curved segment and a straight segment;

FIG. 28 is a section detail through a recessed ceiling trough 24 containing a retractable partition 4;

FIG. 29 is a section detail through a retractable partition 4 shown in the deployed position where its metal base coated with rubber 23 seals the retractable partition 4 to the rubber coated floor of the wind funnel 6;

FIG. 30 is the plan of the retractable multiple direction wind funnel system 22 with a turbine and generator 7, 8 shroud 10 and a piezoelectric oscillators module 27 containing piezoelectric oscillator blades 26. The piezoelectric oscillator blades 26 extract additional wind energy after the turbine and generator 7, 8 to maximize energy production while also acting as sound attenuation;

FIG. 30A is the elevation of the rotating aperture disk 25 which is a circular disk with rotor blades and openings that rotates and makes wind flow intermittently into the piezoelectric oscillators module 27 so that the piezoelectric oscillator blades 26 can oscillate freely;

FIG. 31 is a longitudinal section through the retractable multiple direction wind funnel system 22 as per FIG. 30. The piezoelectric oscillator blades 26 contain piezoelectric material which when bent by the action of incoming wind are compressed to create electricity by the piezoelectric effect. The piezoelectric oscillator blades 26 are fastened between shock absorbers in the concrete floor which allows dismantling for maintenance;

FIG. 32 is the floor plan of the retractable multiple direction wind funnel system 22 similar to FIG. 30 except not using a turbine and generator. Wind is instead funnelled directly and intermittently through the rotating aperture disk 25 and through the piezoelectric oscillators module 27 to generate electricity;

FIG. 33 is a longitudinal section through the retractable multiple direction wind funnel system 22 as per FIG. 32 which does not use a turbine and generator but instead uses only piezoelectric oscillator blades 26;

FIG. 34 is a perspective cutaway view of the piezoelectric oscillators module 27 showing the piezoelectric oscillator blades 26, rotating aperture disk 25, and shroud 10;

FIG. 35 is the plan of the fixed multiple direction wind funnel system 28 showing the arrangement of the four wind funnels with the front wind funnel 6 in the activated position leading to the turbine 7, generator 8, optional secondary turbine rotor 9, shroud 10, and sound attenuation module 11;

FIG. 36 is a longitudinal section through the fixed multiple direction wind funnel system 28;

FIG. 37 is the plan of the fixed multiple direction wind funnel system 28 showing the arrangement of the four wind funnels with the right side wind funnel 6 in the activated position leading to the turbine 7, generator 8, optional secondary turbine rotor 9, shroud 10, and sound attenuation module 11;

FIG. 38 is a cross section through the fixed multiple direction wind funnel system 28 taken near the front wind funnel 6 and looking towards the turbine and generator 7, 8;

FIG. 39 is the plan of the fixed multiple direction wind funnel system 28 showing the arrangement of the four wind funnels with the left side wind funnel 6 in the activated position leading to the turbine 7, generator 8, optional secondary turbine rotor 9, shroud 10, and sound attenuation module 11;

FIG. 40 is a cross section through the fixed multiple direction wind funnel system 28 taken at the location where wind from the front, left side, and right side enter a common funnel area which leads to the turbine and generator 7, 8;

FIG. 41 is the plan of the fixed multiple direction wind funnel system 28 showing the arrangement of the four wind funnels with the back wind funnel 6 in the activated position leading to the turbine 7, generator 8, optional secondary turbine rotor 9, shroud 10, and sound attenuation module 11;

FIG. 42 is a cross section through the fixed multiple direction wind funnel system 28 taken near entrance to the back wind funnel 6 and looking towards the front;

FIG. 43 is the front elevation of the fixed multiple direction wind funnel system 28 showing the wind intake aperture 17 where wind enters through the metal bird screen 3 and retractable partitions 4;

FIG. 44 is the right side elevation of the fixed multiple direction wind funnel system 28 showing the wind intake aperture 17 where wind enters through the metal bird screen 3 and retractable partitions 4;

FIG. 45 is the back elevation of the fixed multiple direction wind funnel system 28 showing the wind intake aperture 17 where wind enters through the metal bird screen 3 and retractable partitions 4;

FIG. 46 is the left side elevation of the fixed multiple direction wind funnel system 28 showing the wind intake aperture 17 where wind enters through the metal bird screen 3 and retractable partitions 4;

FIG. 47 is a longitudinal section through a float on water carrying a wind funnel system 1, 22, 28 which simulates the appearance of a yacht 29 and uses the stabilizing anchoring system of components 31, 32, and 33;

FIG. 48 is the plan of a float on water carrying a wind funnel system 1, 22, 28 which simulates the appearance of a yacht 29 and uses the stabilizing anchoring system of components 31, 32, and 33;

FIG. 49 illustrates the front wind funnel arranged as the active funnel for the auxiliary backup system with its intake aperture closed by having its retractable partitions deployed and with the other retractable partitions deployed to form a funnel to the turbine; and

FIG. 50 illustrates the section of the turbine backup system as per FIG. 49 with the front wind funnel arranged as the active funnel for the auxiliary backup system with its inlet retractable partitions deployed and other retractable partitions deployed to form a funnel to the turbine.

In the drawings the reference numbers which are identical to one another indicate corresponding parts in the different figures.

The systems and components as illustrated and noted in the figures are hereby given general definition, as:
1. Single direction wind funnel system.
2. Building enclosure of roof, walls, and floor.
3. Metal bird screen on which optional decorative building elements can be mounted.
4. Retractable boundary wall partitions of high tensile horizontal metal slats affixed to an air proof fabric.
5. Tensioned cables with guides for the retractable partitions.
6. Wind funnels composed of fixed in place boundary walls forming portions of the ceiling, walls, and floor which are rubber coated or finished with metal or ceramic tiles, and the moveable elements of the retractable partitions.
7. Turbine.
8. Generator connected to the turbine.
9. Optional secondary turbine rotor.
10. Shroud in the shape of a fluted cylinder to increase wind speed and power.
11. Sound attenuation module.
12. Wind exit grille.
13. Grade.
14. Platform to set the invention to an appropriate height.
15. Door in the ceiling of the wind funnel to release over pressure conditions.
16. Pressure release dormers, some being decorative only.
17. Wind intake aperture, denoted by the area defined by the crossed lines on the elevations.
18. Decorative bars of wrought iron or other material mounted on the bird screen.
19. Existing grade.
20. New elevated grade.
21. Foundation piles.
22. Retractable multiple direction wind funnel system.
23. Metal base of the retractable partition coated with rubber.
24. Recessed trough housing a retractable partition.
25. Rotating aperture disk with openings for intermittent wind flow into the piezoelectric oscillators module.
26. Piezoelectric oscillator blades.
27. Piezoelectric oscillators module.
28. Fixed multiple direction wind funnel system.
29. Float carrying a wind funnel system which simulates the appearance of a yacht.
30. Wind exit module with side grilles.
31. Anchoring cable.
32. Intermediate ballast fastened at a specific location along the length of the anchor cable.
33. Anchor ballast which anchors the bottom of the anchoring cable.
100. Overall wind turbine assembly.
102. Main housing.
104. Upright wall portions.
106. Roof portion.
108. Turbine Duct.
110. Turbine Inlet.
112. Turbine Outlet.
114. Turbine Rotor.
116. Inlet Duct.
118. Movable Boundary Wall Partition Guides.
120. Rigid Slats.
121. Movable Boundary wall partition Roller.
122. Movable Boundary wall partition Dispensing Slot.
124. Pressure Relief Duct.
130. Exhaust Grills.
132. Secondary Housing Inlet.
134. Secondary Housing Outlet.
140. Sinuous Exhaust Duct.
150. Gated Area.
160. Fixed Valve Plate.
162. Rotating Valve Plate.
164. Small Valve Aperture.
166. Large Valve Aperture.
168. Perimeter Blades.
170. First End of Oscillating Blade.
172. Second End of Oscillating Blade.
174. Ceiling fans mounted in the ceiling of the funnels.
176. Roof vent air intake for the ceiling fans.

### DETAILED DESCRIPTION

The embodiments described as being implemented in form, materials, instrumentation, and other apparatus will be apparent to those persons skilled in the art. The scope of the invention as described and illustrated through the figures shall not be limited to the specific embodiments as described and illustrated by the figures but shall cover other embodiments possible through the adjustment of component parts. Minor component variations shall in no way limit the scope of the invention. As such this patent claims rights over similar embodiments of the invention as described and illustrated, and shall also encompass future upgrades to any of the component parts as described herein. The following is a detailed description of the invention and its preferred embodiments with references to figures which illustrate the arrangement of component parts such that anyone skilled in the art shall be able to practice use of the invention, and wherein:

Referring to the accompanying figures, there is illustrated a wind turbine assembly generally indicated by reference numeral 100. The assembly 100 is used in various forms for generating electricity from wind power. Although various embodiments are shown in the accompanying figures, the common features of the various embodiments will first be described herein.

The turbine assembly 100 includes a main housing 102 comprised of a perimeter of fixed, upright wall portions 104 and a roof portion 106 which surround the sides and top of a hollow interior of the housing. A turbine 7 is mounted inside the main housing 102 which includes a turbine duct 108 which is elongate in a longitudinal flow direction through the turbine. The duct extends from a turbine inlet 110 to a turbine outlet 112 and supports a turbine rotor 114 at an intermediate location therein. The rotor is rotatable about a longitudinal axis of the turbine duct 108 and includes blades which are arranged to rotate the turbine in response to a flow of wind through the duct from the inlet to the outlet. A generator 8 is coupled to the turbine rotor 114 so as to be driven to rotate by the rotating rotor to generate electricity. The generator is located downstream from the rotor. An optional secondary turbine rotor 9 is in turn located downstream from the generator for rotation together with the turbine rotor to augment power recovered by the generator. The outlet 112 of the turbine is coupled to a shroud 10 which diverges or enlarges in cross section as it extends outwardly in a longitudinal direction from the rotor. The shroud is exhausted externally of the main housing and serves to accelerate the flow of wind exiting the turbine rotor.

The main housing includes at least one inlet opening 17, also referred to herein as a wind intake aperture, which is located in a respective one of the upright wall portions of the main housing. Specifically, the inlet opening 17 spans a majority of the size and area of the respective upright wall portion or respective side of the housing within which it is located.

Each inlet opening 17 communicates with a respective inlet duct 116 formed of a plurality of boundary walls which define a respective boundary of an inlet duct from the respective inlet opening 17 to the inlet 110 of the turbine. The floor or bottom boundary wall of each inlet duct 116 is generally fixed and sloped downwardly from the turbine inlet to the respective inlet opening 17 in the housing so as to be sloped downwardly to the exterior of the housing.

A screen 3 is mounted across each inlet opening 17 so as to be substantially flush with the respective surrounding wall portion. The screen 3 comprises a rigid open mesh or grid which readily allows the flow of incoming air therethrough. Decorative bars 18 may be mounted externally across the screen 3 with respective imagery or shapes being provided on the bars to visually represent components of a conventional building, including windows and the like, to disguise the respective inlet opening.

The turbine assembly further includes a plurality of moveable boundary wall partitions, also referred to herein as retractable partitions, mounted at various locations for opening, partially closing or fully closing respective inlet ducts. More specifically, each inlet opening is provided with a plurality of boundary wall partitions mounted in series in a common plane immediately to the interior side of the respective screen 3 so as to be substantially flush with the exterior side of the main housing. Each boundary wall partition 4 is moveable between an open position in which the respective portion of the inlet opening is unobstructed by the boundary wall partition, and a closed or deployed position in which the respective portion of the inlet opening is closed by the partition. In a fully closed arrangement of the inlet opening of a given inlet duct, all of the boundary wall partitions 4 of that inlet opening collectively span across and fully close or restrict the inlet opening to prevent the flow of air therethrough. All of the moveable boundary wall partitions at each inlet opening are generally only closed or deployed when that respective inlet opening is not in use. In some instances, however, only some of the partitions 4 associated with a given inlet opening are closed while others remain open so that the inlet opening remains partially open. This arrangement may be suitable when wind approaches at an oblique angle, for example at 45 degrees, to the plane of the inlet, as only a segment of the retractable partitions associated with one or more inlet ducts may need to be opened to catch winds and direct them into the funnel duct in this instance.

Each boundary wall partition is supported by a respective pair of guides 118 which are mounted parallel and spaced apart from one another in the form of generally U-shaped channels. Each moveable boundary wall partition is supported by a respective pair of the guides in which the open side of the channels face inwardly towards one another to receive opposing side edges of the respective boundary wall partition therebetween. At each inlet opening, one guide is provided against each upright boundary wall in fixed relation to the wall. At evenly spaced intermediate locations between the two walls, additional guides 118 are provided such that the intermediate guides are supported in pairs, supported by a common support cable 5, to which the two guides are mounted. Each cable spans under tension between opposing top and bottom walls of the respective inlet duct such that the tension of the cable provides adequate support to maintain the guides perpendicular to the wind flow direction of the duct.

Each moveable boundary wall partition 4 comprises a fabric sheet which may be flexible, which is air proof and which is mounted on a roller 121 for operation between deployed and stored positions. A plurality of rigid slats 120 are provided at spaced apart positions in parallel relation with one another across the fabric sheet such that each of the slats spans between the two opposing side edges of the moveable boundary wall partition that is received within the U-shaped channel guides 118. The fabric spanning between the rigid slats permits the slats to be angularly offset relative to one another. In this manner, the bottom edge 23 of each partition 4 can be abutted against a sloped bottom wall so as to be non-parallel to the roller axis supporting the partition rolled thereon by orienting the slats to be closer together along one side edge of the partition than the other side edge as best shown in FIG. 26.

Each partition is rolled onto the respective roller 121 which is housed within a respective trough recessed up above the top boundary wall or ceiling of the respective duct. A dispensing slot 122 is provided in the top wall of the housing in proximity to the roller through which the material of the partition can be dispensed in the closed position. More specifically in the closed position, the material of the partition is dispensed and unrolled from the roller such that it extends through the dispensing slot 122 in the top wall and the bottom edge 23 abuts the opposing bottom boundary wall or floor of the duct.

The bottom edge 23 includes a strip of resilient sealing material along the bottom side thereof for sealing engagement with the bottom boundary wall in the deployed or closed position. Alternatively, when it is desired to open the partitions into a stored position, the rollers are actuated such that the material of the respective moveable boundary wall partition 4 is retracted upwardly through the dispensing slot 122 to be located entirely in the trough housing the roller while the bottom edge 23 is received in the dispensing slot 122 such that the sealing material along the bottom edge thereof is flush with the interior surface of the top wall of the duct and the dispensing slot 122 is sealed closed by the bottom edge 23.

Each inlet duct further includes a pressure relief duct 124 in communication between a pressure relief door 15 mounted within a respective opening in the top wall of each duct such that it is movable between open and closed positions. The pressure relief duct communicates from the pressure relief door 15 to the exterior of the main housing, typically through the roof portion thereof. The door 15 is biased to a closed position flush with the top wall of the inlet duct but is moveable to an open position in response to wind pressure within the inlet duct which exceeds a respective upper pressure limit as sensed by a suitable sensor in the duct. When the door is open, the inlet duct communicates through the pressure relief duct to vent some of the air pressure to the exterior of the housing.

The inlet duct in each instance is funnel shaped to be continuously reduced in cross section from the inlet opening to the inlet of the turbine to thereby concentrate and increase the incoming wind pressure as the wind is funnelled towards the inlet of the turbine. The pressure relief duct 124 thus permits excess wind pressure to be vented externally before causing damage to the turbine or other components of the assembly in excess wind conditions.

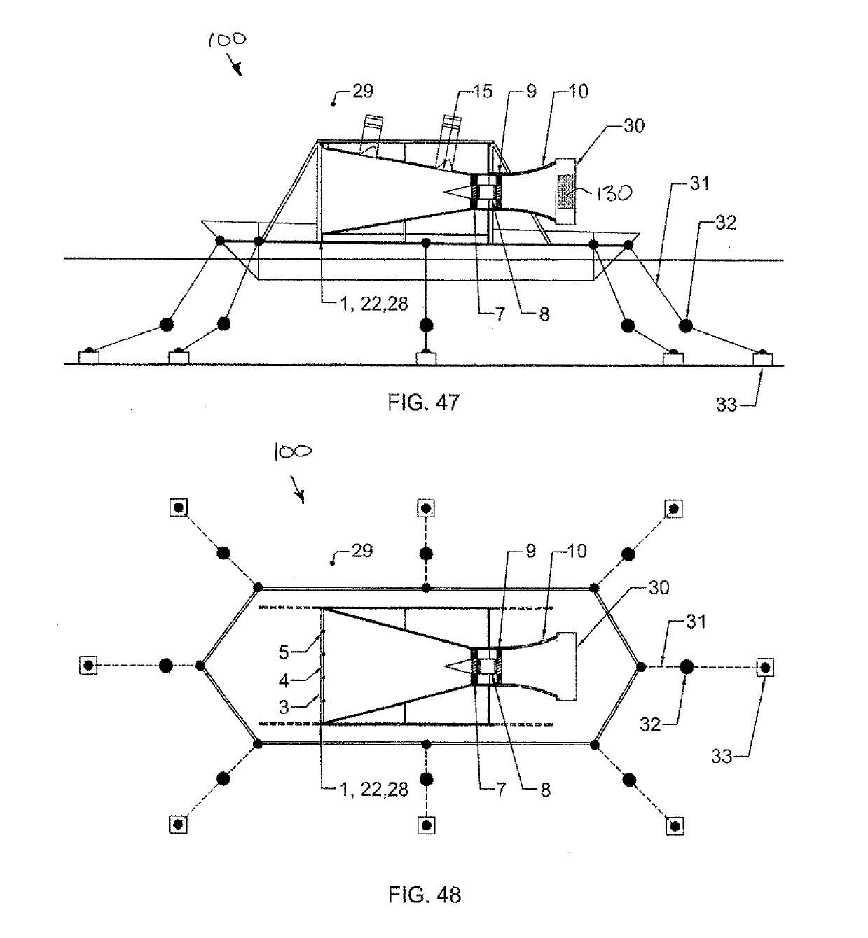

Turning now to FIGS. 47 and 48, according to one embodiment of the present invention, the main housing is arranged such that the roof portion, the upright wall portions, and the screen 3 are arranged to visually represent a marine vessel, for example a yacht and the like. The exhaust shroud 10 in this instance communicates with an exhaust module 30 in the form of an enclosed secondary housing with laterally opposed grills 130 formed therein which redirect the exhaust transversely outward relative to the longitudinal wind flow direction.

The main housing in this instance comprises a buoyant frame arranged to float the turbine supported thereon such that it is above the water surface. The housing in this instance includes a single inlet opening communicating a single funnel shaped inlet duct, although in further embodiments additional inlet ducts may be provided similar to the other illustrated embodiments described below. The pressure relief duct in this instance may be configured to resemble a chimney stack of the type commonly found on large marine vessels.

The housing is supported in a substantially fixed location on the body of water by an anchoring system comprised of a plurality of cables 31. Each cable extends generally radially outward from the frame of the main housing from a first end of the cable coupled to the main housing at the perimeter thereof to a second end which is anchored by a terminal anchor 33 fixed on the seabed. The second ends are situated laterally and radially outward from the perimeter of the housing upon which the first ends of the cables are mounted. The cables are provided with sufficient length that there is some slack in the cables.

When the height of the body of water swells upwardly, there is sufficient slack that the cables can be extended to a first position corresponding to a maximum first distance between the first end and the second end of each cable. When the height of the body of water is reduced such that the housing falls relative to the first position, suitable biasing is provided by an intermediate ballast 32 mounted at an intermediate location on each cable to bias a central location of the cable downward which in turn biases each cable away from the first position towards any one of a plurality of second positions where the distance between the opposing first and second ends is reduced as compared to the first position. The ballasted arrangement of the cables maintains the turbine assembly at a stabilized angular orientation and elevation relative to wind currents despite variations in the height in the body of water due to waves, or tides and the like.

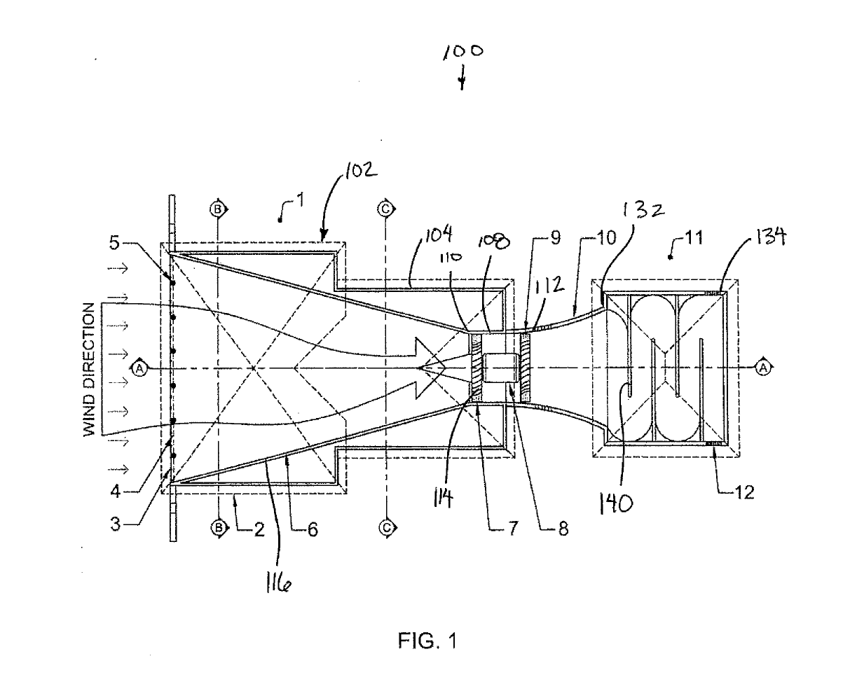

Turning now to the remaining FIGS. 1 through 46, in these embodiments, the roof portion, the upright wall portions, and the screens over the inlet openings of the main housing in each instance is configured to resemble a building, for example a residential house and the like. The main housing is thus typically supported directly on a foundation on the ground in fixed relation thereto. The pressure relief ducts 124 in this instance communicate through the roof portion and are vented externally through structures which visually represent dormers on the roof.

Furthermore, in each of the remaining embodiments of FIGS. 1 through 46, a secondary housing 11 also referred to herein as a sound attenuation module is provided. In each instance, the secondary housing 11 is mounted separately from the main housing so as to be spaced therefrom. The secondary housing extends from an inlet 132 at the front end to an outlet 134 adjacent the rear end so as to direct a flow longitudinally therethrough from the inlet to the outlet. The inlet 132 is coupled to the shroud 10 to receive the flow exhausted from the main housing with the flow being subsequently directed outward through a pair of laterally opposed grills 12 directed outwardly in opposing directions transversely to the longitudinal direction through the housing.

Turning now more particularly to the first embodiment of FIGS. 1 through 9, the main housing includes a single inlet opening at the front side thereof longitudinally opposite from the turbine which exhausts through the rear wall. The single inlet duct is funnel shaped and tapers inwardly in cross section from a maximum cross sectional area at the inlet opening to a minimum cross sectional area at the inlet of the turbine 7. The exhaust then continues rearwardly out of the housing to the secondary housing located rearward of the main housing. An exhaust duct 140 is provided within the secondary housing which is directed by baffles to follow a sinuous path from the inlet to the exhaust grills 12 of the secondary housing. All of the boundary walls of the duct are fixed in this instance. In the first embodiment, the main housing and the secondary housing are supported directly on the ground by a suitable foundation structure substantially at ground level.

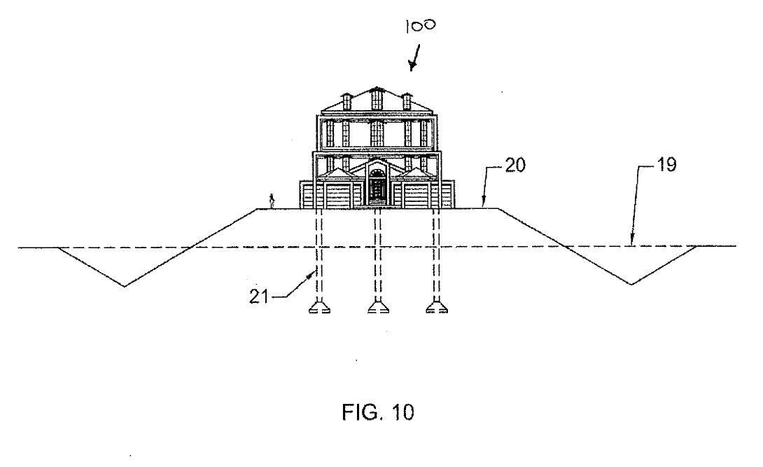

As shown alternatively in FIG. 10, an earthen mound 20 may be formed by relocating earth from a surrounding peripheral area 19 to raise the grade level of the main and secondary housings. Piles 21 can be used to provide support for the main housing directly in relation to unexcavated earth below the earthen mound. In this manner, the main housing remains supported on the ground but in raised elevation relative to the surrounding grade to take advantage of more optimal winds in some instances.

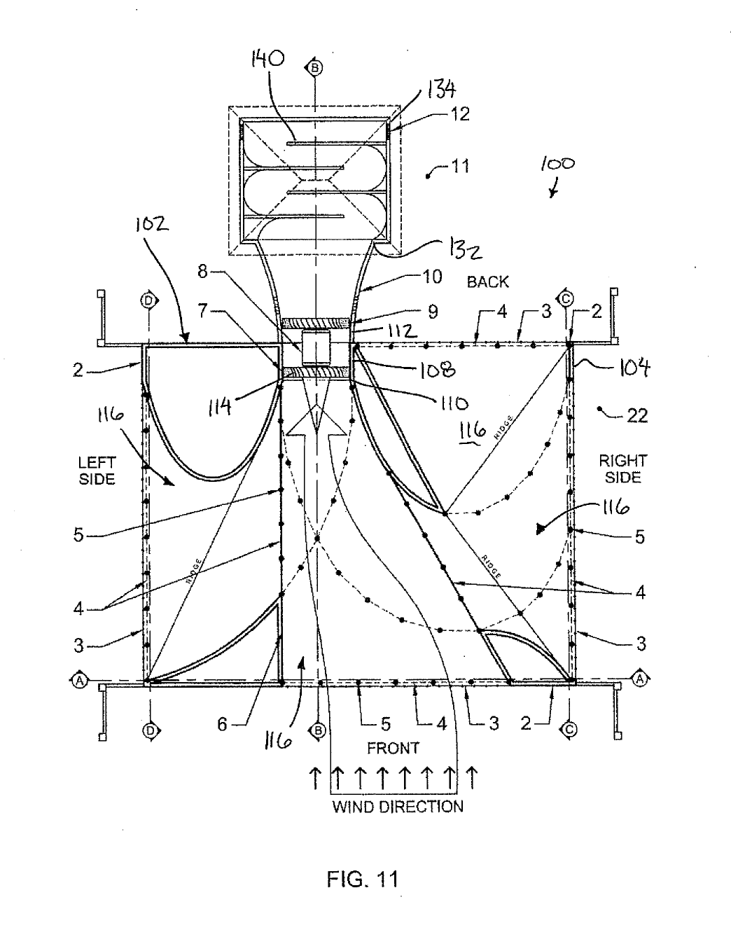

Turning now to FIGS. 11 through 29, a plurality of inlet openings are provided in the housing in this instance such that one inlet opening is provided on each of four sides of a rectangular perimeter of the main housing. The turbine again communicates through the rear side of the housing to a secondary housing rearward of the main housing. On the front and two laterally opposed sides of the main housing, the inlet opening spans a majority of the area of the side wall of the structure. At the rear wall, the turbine is offset to one side while the inlet opening of the rear facing duct is substantially offset fully to one side of the turbine.

The inlet ducts in this instance are each formed by a combination of fixed boundary wall partitions 6 and moveable boundary wall partitions 4 which are substantially identical in configuration to the moveable boundary wall partitions 4 described above which span across the inlet openings which are not in use or which are partially closed by a portion of the wall partitions 4. More particularly, each inlet duct includes a plurality of moveable boundary wall partitions associated therewith which form a majority of the side boundary walls of that duct. The moveable partitions are operable between a deployed position fully spanning between opposing top and bottom boundary wall partitions of the duct to form a respective portion of the side boundary of the respective inlet duct. In this position, the boundary wall partition blocks the flow from one or more other inlet ducts of the main housing.

The moveable boundary wall partitions are each also moveable to a respective stored position in which the boundary wall partition is retracted into a respective trough above the top wall of the respective duct as described above. In the stored position, the partition does not provide obstruction to any other ducts, such that the inlet ducts may have respective overlapping portions as they communicate inwardly towards the inlet of the turbine.

The moveable boundary wall partitions are operated into different combinations of opened and closed positions such that typically only a single one of the inlet ducts communicates from the respective inlet opening to the inlet of the turbine at any given time when the wind is directed primarily onto only one of the sides of the housing dependent upon which direction the wind is coming from. Typically the moveable boundary wall partitions 4 which form boundaries of the inlet ducts are mounted laterally in series with one another to form a continuous side boundary wall of the respective duct. In this instance, each planar moveable boundary wall partition in the closed or deployed position is angularly offset about a vertical axis relative to adjacent boundary wall partitions to form a gradually curved boundary redirecting the air flow from either one of the side inlet openings or the rear inlet opening and is to be directed into the inlet of the turbine.

In instances when the wind is directed onto more than one side of the housing at an oblique angle, two adjacent inlet ducts may fully or partially communicate with the funnel inlet to the turbine by fully or partially opening the respective inlet openings using all or only some of the movable partitions 4 in the open position.

The secondary housing and the embodiment of FIGS. 11 through 29 is substantially identical to the previous embodiment by providing an exhaust duct which follows a sinuous path from the inlet to the exhaust grills 12 of the secondary housing.

Turning now to the embodiment of FIGS. 35 through 46, the main housing in this instance again comprises multiple inlet openings on each of four sides of a rectangular perimeter of a main housing with the turbine exhausting through the rear wall to a secondary housing including a sinuous exhaust duct 140 therein. The main housing in the embodiment of FIGS. 35 through 46 differs mainly in that the inlet opening of each of the four sides spans substantially the entire side of the housing so that the four inlet ducts all have side boundary walls sloping inwardly from the corners of the main housing at an angle that may vary depending on the unit size and proportion. The walls of the inlet duct are also mostly fixed in this instance with only a small gated area 150 being provided at the center of the main housing. A plurality of the moveable boundary wall partitions 4 are provided within the gated area 150 to again permit only a single inlet duct to communicate with the inlet of the turbine at any given time dependent upon the wind direction.

The inlet duct at the rear side is located above the turbine duct which is closest to the bottom side of the main housing. One or more moveable boundary wall partitions 4 may be provided forming part of the top wall of the turbine duct leading up to the inlet of the turbine such that oncoming wind entering the rear of the housing above the turbine duct can be redirected by suitable boundary walls of the inlet duct downwardly through an open moveable boundary wall partition 4 and the top side of the turbine duct where it is subsequently redirected rearwardly into the inlet of the turbine with the remainder of the gated area 150 being closed by other moveable boundary wall partitions 4.

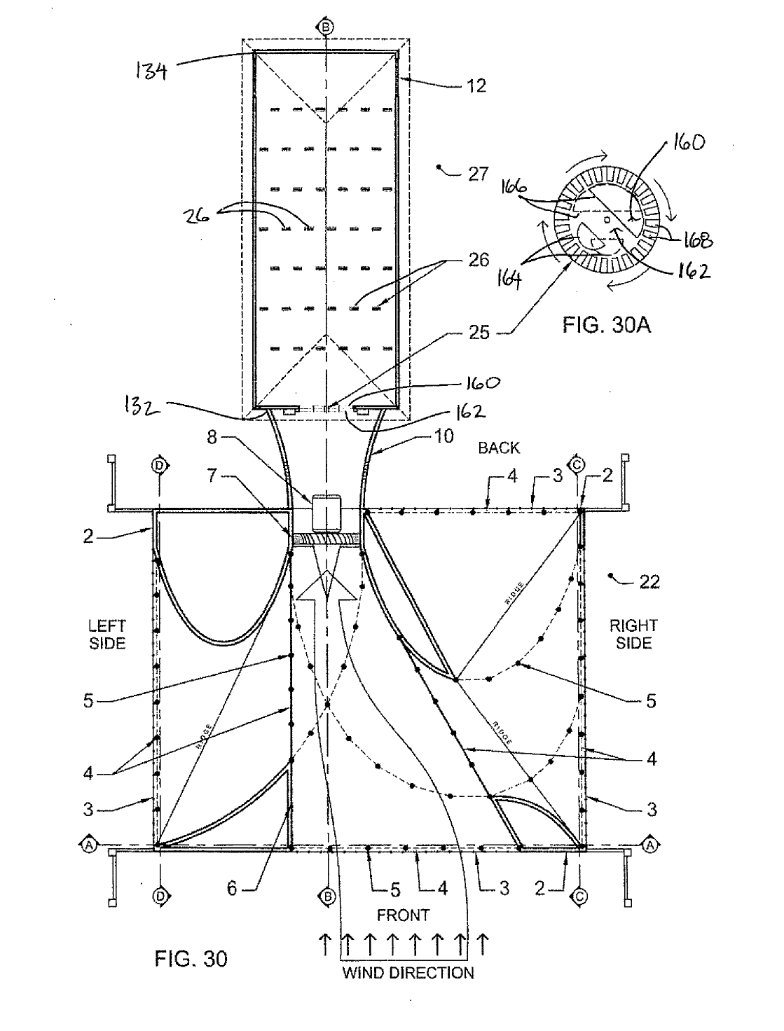

Turning now to the embodiment of FIGS. 30 through 34, the main housing in this instance is substantially identical to the embodiment of FIGS. 11 through 29, however the secondary housing in this instance is modified to replace the exhaust ducting with an energy reclaim device 29 also referred to herein as a piezoelectric oscillator module. Specifically, the energy reclaim device comprises a plurality of piezoelectric oscillator blades 26 supported within the housing for oscillating movement in response to a cyclically intermittent flow of air through the housing from the inlet at the front in communication with the shroud 10 to the outlet through the exhaust grills 12 adjacent the rear.

To produce the cyclical intermittent flow, a valve device 25 is provided at the inlet of the secondary housing in communication with the shroud. The valve device includes a fixed plate 160 and a rotating plate 162 which is directly adjacent and rotatable relative to the fixed plate for rotation about a longitudinal axis oriented in the flow direction of the shroud and secondary housing. Each of the plates includes a similar pattern of a small aperture 164 diametrically opposite from a large aperture 166 such that the apertures align with respective ones of the corresponding apertures in the other plate at a single point in the rotation of the rotating plate. As the apertures intermittently overlap one another, the valve device effectively opens and closes so as to be operable between a first position in which flow is permitted readily therethrough and a second position in which the flow is restricted relative to the first position. The rotating plate 162 also includes a plurality of perimeter blades 168 which serve to drive the rotation of the rotating plate under force of the wind through the inlet of the secondary housing, however, an additional motor of various means may be provided to drive the rotation at a controllable speed if desired.

The oscillating blade members 26 each comprise an elongate and flat main body extending longitudinally from a first end 170 fixed to the bottom wall of the secondary housing and an opposing second end 172 which is freely supported within the hollow interior of the secondary housing in close proximity to the top wall of the housing due to the blade members spanning nearly the full height of the secondary housing. Each blade member is flat in a direction which is perpendicular to the longitudinal flow direction through the housing and is elongate in an upright direction. Accordingly, each blade is well suited for bending generally about a horizontal axis perpendicular to the longitudinal flow direction. The bending results in the upper second free end 172 of each blade member oscillating forwardly and backwardly generally in the longitudinal direction between the inlet and outlet ends of the housing. Piezoelectric material is joined along the main body of each blade member so as to be subjected to the bending stresses of the blade to cause the piezoelectric material to be alternately compressed and released to generate an electrical current.

The blade members are mounted in an array of rows such that a plurality of blades are laterally spaced apart in each row and the laterally oriented rows are longitudinally spaced apart between the front and rear ends of the secondary housing. The blades are spaced apart relative to adjacent blades in the same row by a distance corresponding approximately to the lateral width of each blade. Furthermore, each blade is supported to be offset in the lateral direction relative to the blades of an adjacent row.

As shown in the embodiment of FIGS. 30 through 34, the oscillating blade members capture additional wind energy exhausted from the main turbine 7.

In further embodiments, the oscillating blade members may be provided as a stand-alone wind driven energy generating device for directly receiving an on-coming flow of wind rather than receiving only a secondary flow downstream of a primary device such as a turbine.

With reference to individual Figures, the invention will now be further described.

FIG. 1 is the floor plan of the single direction wind funnel system 1 where 2 is the building enclosure of the roof, walls, and floor within which the ceiling, walls, and floor of the wind funnel 6 are located. The entrance to the wind funnel 6 is covered by a bird screen 3 made of metal or other material and behind which are retractable partitions 4 between tensioned cables with guides 5. The openings in the screen 3 are thus suitably sized to restrict entrance of birds and other similarly sized debris. The retractable partitions 4 that are located at the entrance to the wind funnel 6 serve to control and modulate the intake of wind for optimal performance and serve to protect the invention from wind gusts. When wind gusts occur these retractable partitions 4 will close automatically as monitored and activated by sensors and powered by electric motors or a pneumatic air system. Wind entering the wind funnels 6 at speeds of between five to ten kilometres per hour and more is accelerated along its path by the decreasing cross sectional area of the wind funnel 6 leading to the turbine and generator 7, 8 and an optional secondary turbine rotor 9 to create electricity. A shroud 10 is located after the turbine and generator 7, 8 and is used to increase the wind's speed and power and subsequently connects to a sound attenuation module 11 to mitigate any noise;

The building enclosure of the roof, walls, and floor 2, with or without decorative elements such as wood, wrought iron, plastic, or other material, acts to house the wind funnels 6 while simulating the appearance of a house, barn, or other building form to aesthetically integrate with the architecture where it is located;

Bars of wrought iron, plastic, or other material that is surface applied to the metal bird screen 3 is for the purpose of simulating the appearance of a house, barn, or other building form to aesthetically integrate with the local architecture where the invention is located and allows wind to flow through the metal bird screen 3 at the opening of the wind funnel with minimal resistance;

The retractable partitions 4 are made of an air proof fabric on which high tensile metal slats are affixed. The retractable partitions 4 roll up or down between tensioned cables with guides 5 that are fastened to the floor and roof structure. The retractable partitions 4 control the amount of air entering the wind funnel 6. They are activated by sensors and powered by an electric motor or a pneumatic air system. In their deployed position the retractable partitions 4 form an airtight seal with the wind funnel floor 6 using a rubber coated metal base. An airtight connection is also made with its track guides when deployed. Using a Teflon coated magnetized rubber sleeve fastened to each side of the track guide in conjunction with similarly magnetized metal slat edges an airtight seal is created with the track guides. The track guides are also heat traced so the metal slats with their sliding key holders can slide easily in cold weather. The tensioned cables with guides 5 for the retractable partitions 4 can be heat traced or may use infrared lights in low temperature environments to mitigate freezing conditions.

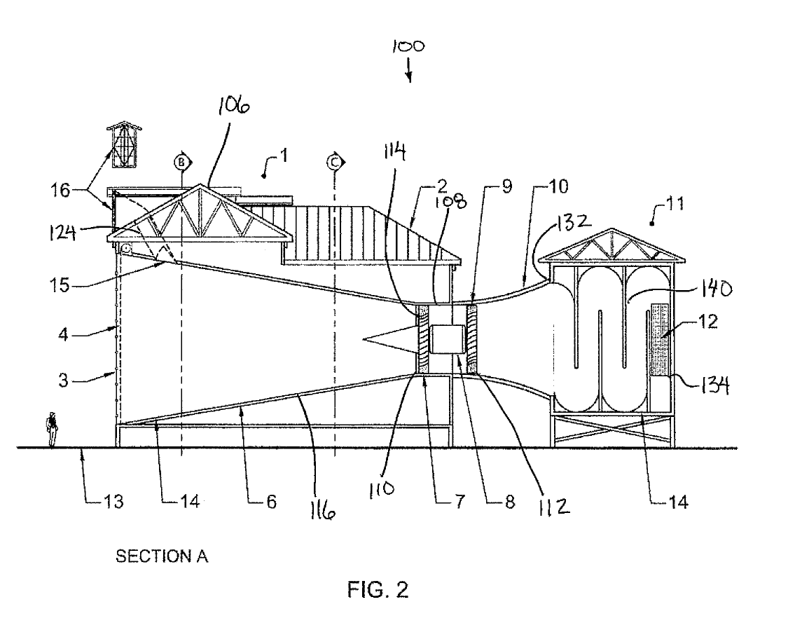

FIG. 2 is a longitudinal section through the single direction wind funnel system 1. The invention can be elevated to an optimal height if necessary by use of a platform 14 to capture the wind. Pressure release dormers 16 located on the roof 2 are used to release over pressure conditions within the wind funnel 6 and these open and close automatically by a door closer which is monitored by sensors and activated by pneumatic air or an electric motor. Component 15 is a door in the ceiling of the wind funnel 6 which operates similar to and in concert with the pressure release dormers 16. The sloping floor of the wind funnel 6 accentuates the funnel geometry while also allowing for the drainage of rainwater or snow melt through the metal bird screen 3 and thereby eliminates the need for floor drains within the wind funnel 6 which could otherwise reduce wind speed.

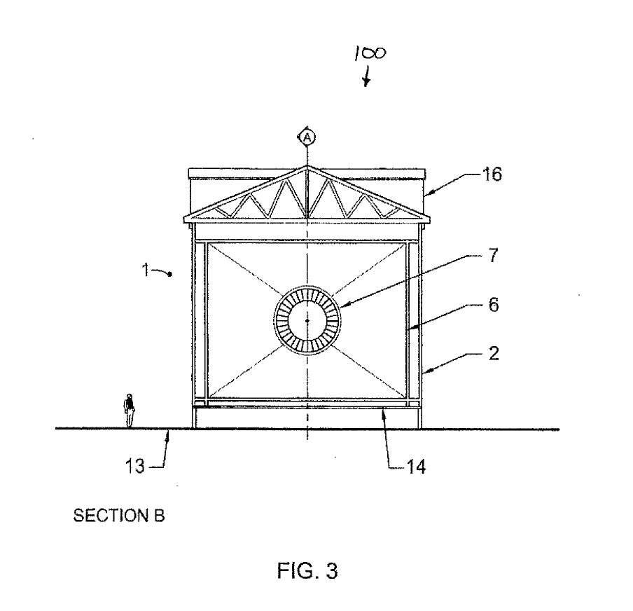

FIG. 3 is a cross section through the wind funnel 6 looking towards the turbine and generator 7, 8.

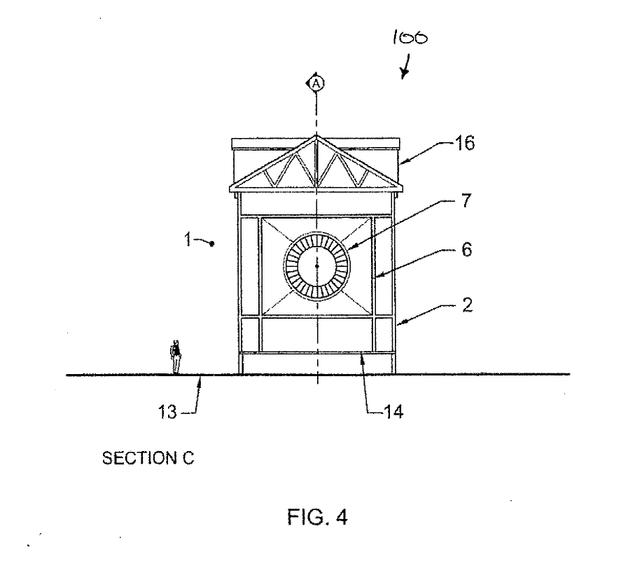

FIG. 4 is a cross section through the wind funnel 6 taken close to the turbine and generator 7, 8 illustrating the decreasing cross sectional area of the wind funnel 6 as it nears the turbine and generator 7, 8.

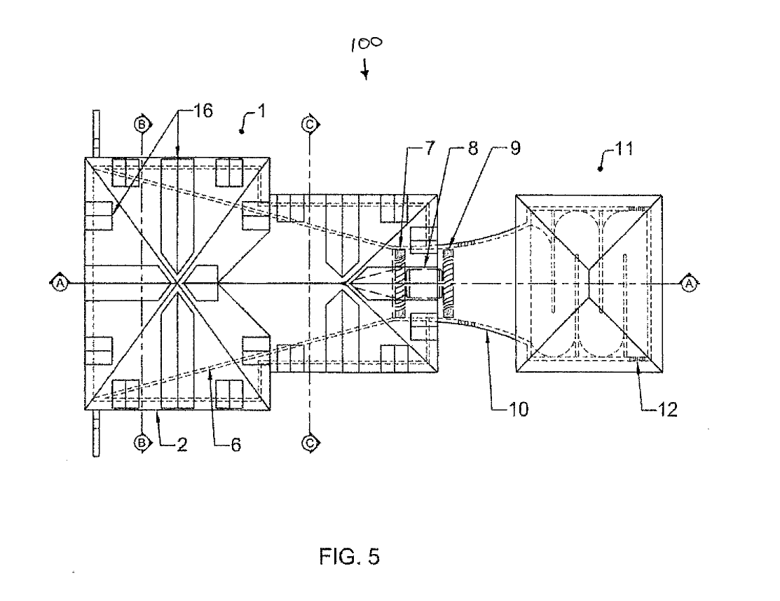

FIG. 5 is the roof plan showing the single direction wind funnel system 1 with pressure release dormers 16 shroud 10 and sound attenuation module 11.

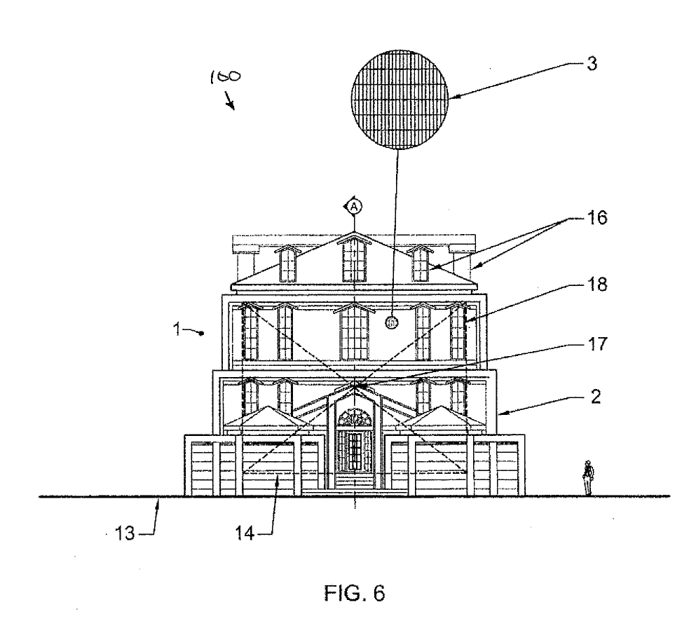

FIG. 6 is the front elevation of the single direction wind funnel system 1. Wind enters through the wind intake aperture 17 through the metal bird screen 3 having minimal resistance to the flow of wind and behind which retractable partitions 4 modulate the flow of incoming wind and may be deployed to protect the invention from wind gusts. The appearance of the building enclosure 2 and the decorative bars 18 mounted to the metal bird screen 3 are variable in expression and depend on the area where the invention is located. This is typical for all elevations of this wind funnel system, and generally for all of the various preferred embodiments of the invention.

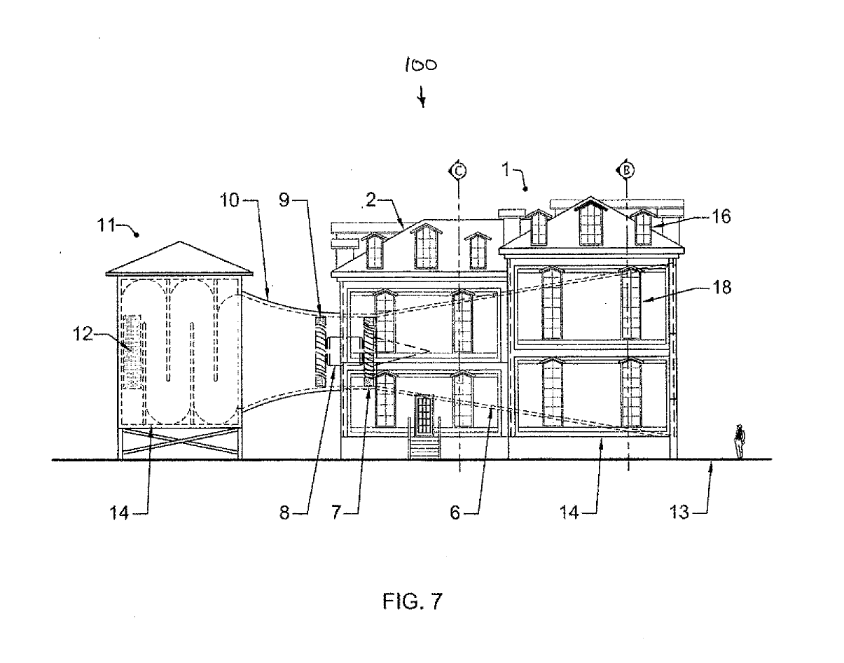

FIG. 7 is the left side elevation of the single direction wind funnel system 1 showing the wind intake aperture 17 and other components as indicated.

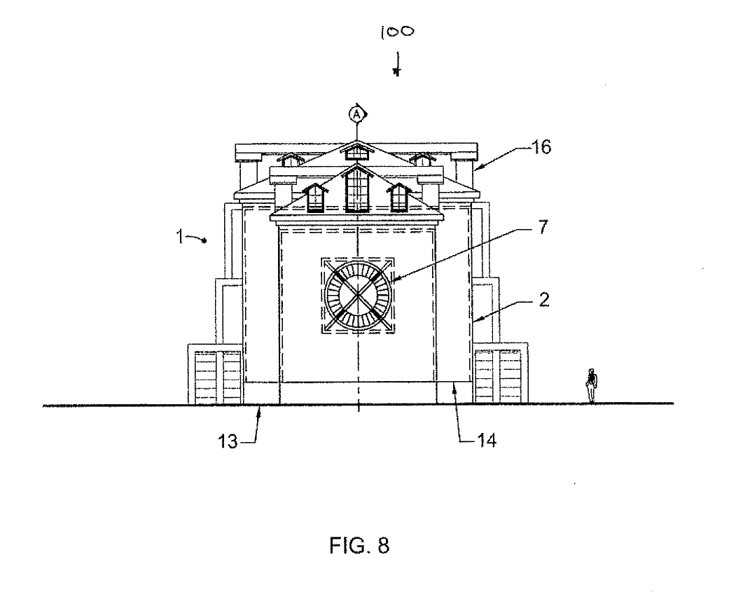

FIG. 8 is the back elevation of the single direction wind funnel system 1 showing the wind intake aperture 17 and other components as indicated;

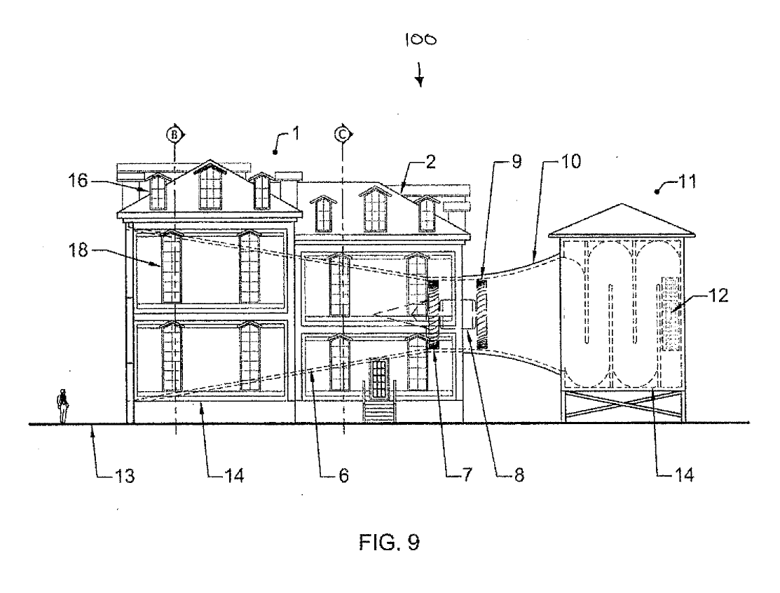

FIG. 9 is the right side elevation single direction wind funnel system 1 showing the wind intake aperture 17 and other components as indicated.

FIG. 10 illustrates an economical method of elevating the invention by creating a new elevated grade level by moving earth and using foundation piles 21 to the depth of undisturbed soil so there is no need for compaction of fill material which would otherwise be necessary to support the invention at a new elevated grade level.

FIG. 11 is the plan of the retractable multiple direction wind funnel system 22. This embodiment illustrates that incoming wind which may be from various directions is able to be directed to a single location with a turbine and generator to produce electricity. Since a wind funnel building would require much effort to be rotated to capture wind from various directions, the multiple directional wind funnel system 22 demonstrates that by the use of retractable partitions 4 specific wind funnels 6 can be created to capture wind singularly from any of four directions. The retractable partitions 4 are made of an air proof fabric with horizontal metal bands. By using sensors and activated by electric motors or a pneumatic air system, specific retractable partitions 4 deploy from the ceiling of the wind funnel 6 along specific cable and guide 5 arrangements to form direction specific wind funnels 6 leading to the turbine and generator 7, 8. FIG. 11 illustrates the specific arrangement of cables and guides 5 and retractable partitions 4 in the deployed position which form an active wind funnel 6 to capture wind coming from the front. The remaining cables and guides 5 are in latent status with their retractable partitions 4 in retracted position.

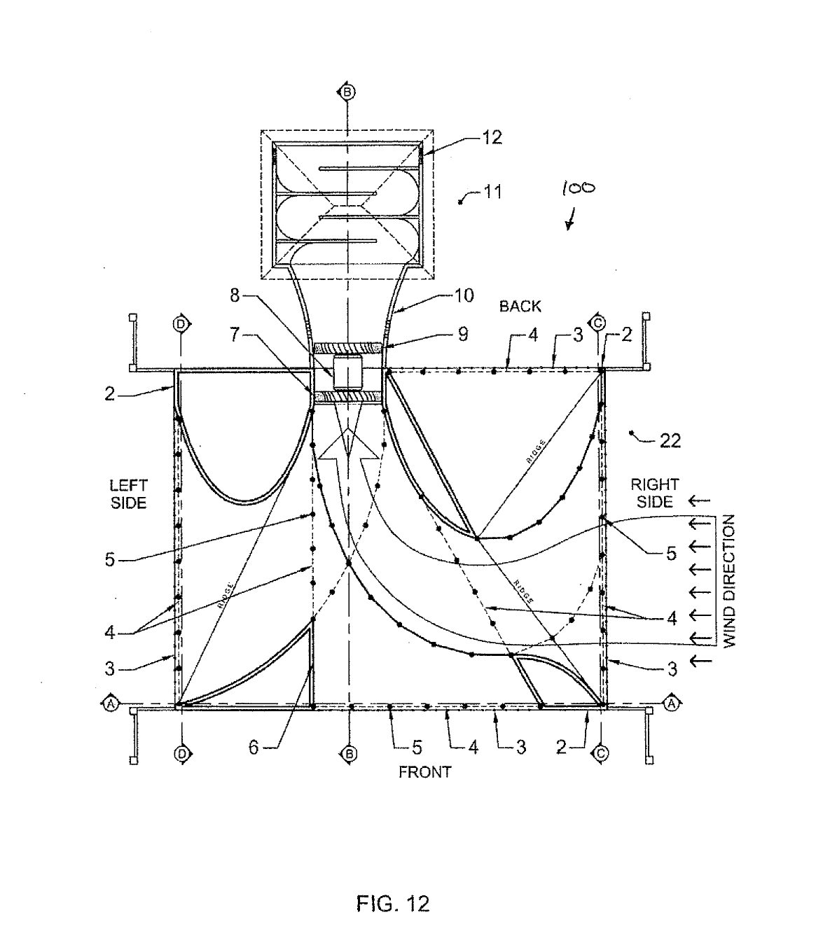

FIG. 12 illustrates the specific arrangement of cables and guides 5 and retractable partitions 4 in the deployed position which form an active wind funnel 6 to capture wind coming from the right side. The remaining cables and guides 5 are in latent status with their retractable partitions 4 in retracted position.

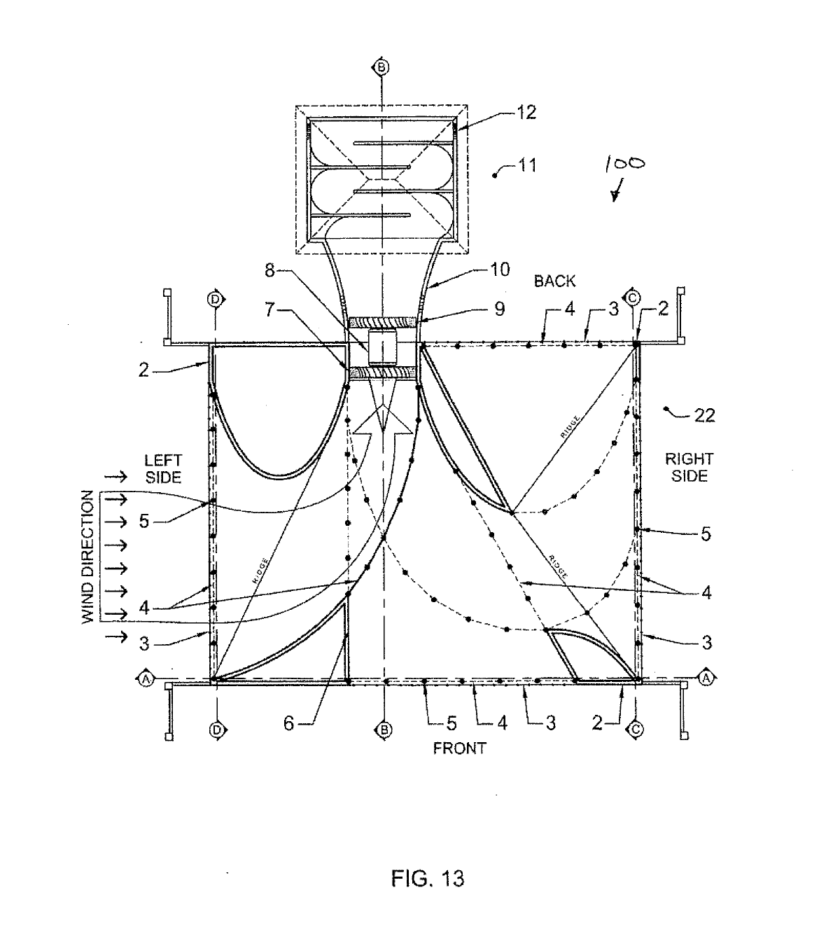

FIG. 13 illustrates the specific arrangement of cables and guides 5 and retractable partitions 4 in the deployed position which form an active wind funnel 6 to capture wind coming from the left side. The remaining cables and guides 5 are in latent status with their retractable partitions 4 in retracted position.

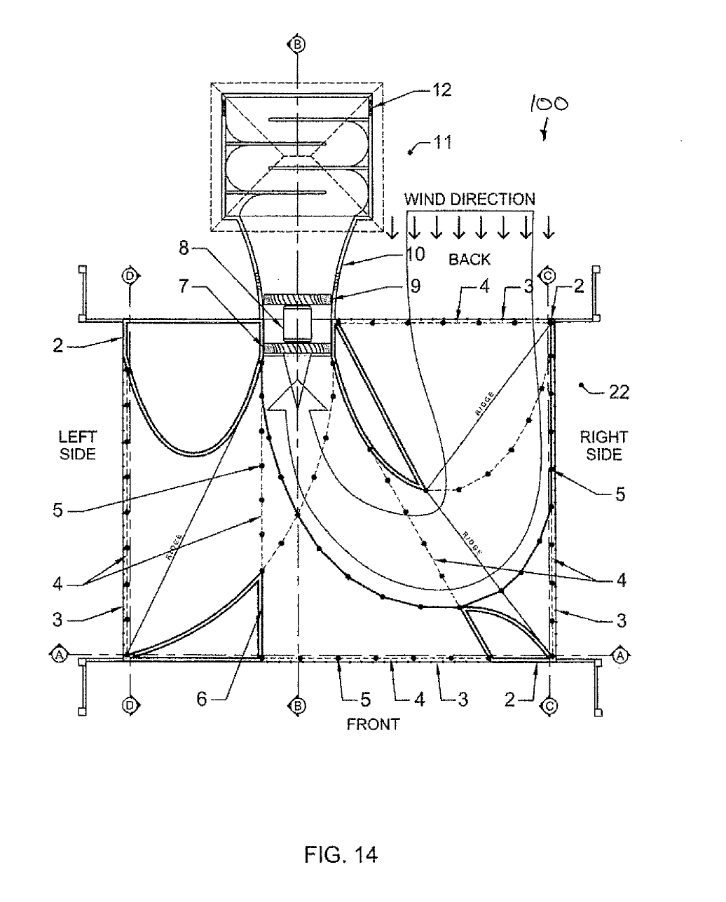

FIG. 14 illustrates the specific arrangement of cables and guides 5 and retractable partitions 4 in the deployed position which form an active wind funnel 6 to capture wind coming from the back. The remaining cables and guides 5 are in latent status with their retractable partitions 4 in retracted position.

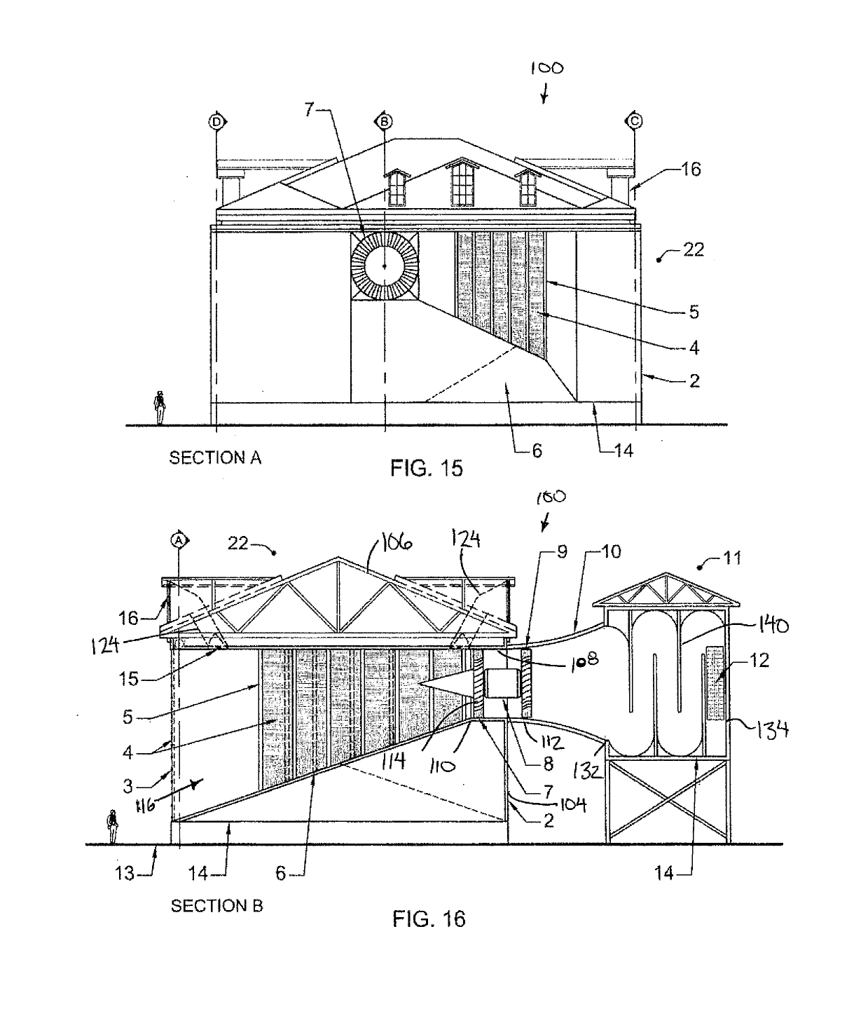

FIG. 15 is a cross section through the retractable multiple direction wind funnel system 22 with the front wind funnel 6 in the activated position.

FIG. 16 is a longitudinal section through the retractable multiple direction wind funnel system 22 with the front wind funnel 6 in the activated position.

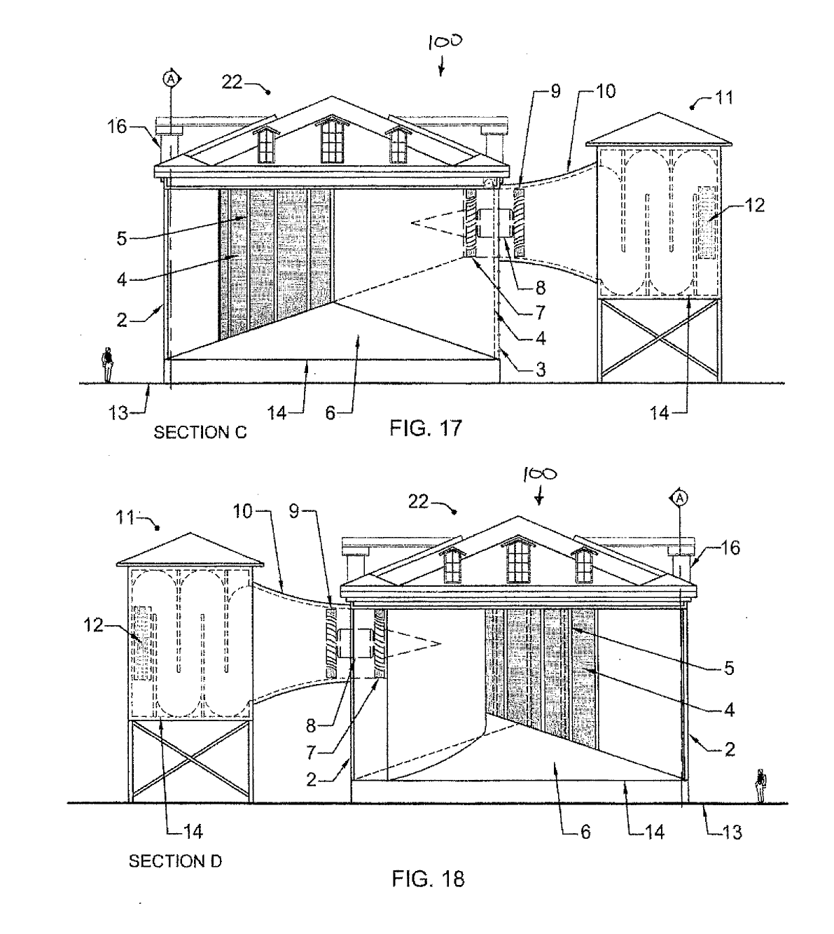

FIG. 17 is a longitudinal section through the retractable multiple direction wind funnel system 22 with the back wind funnel 6 in the activated position.

FIG. 18 is a longitudinal section through the retractable multiple direction wind funnel system 22 with the left side wind funnel 6 in the activated position;

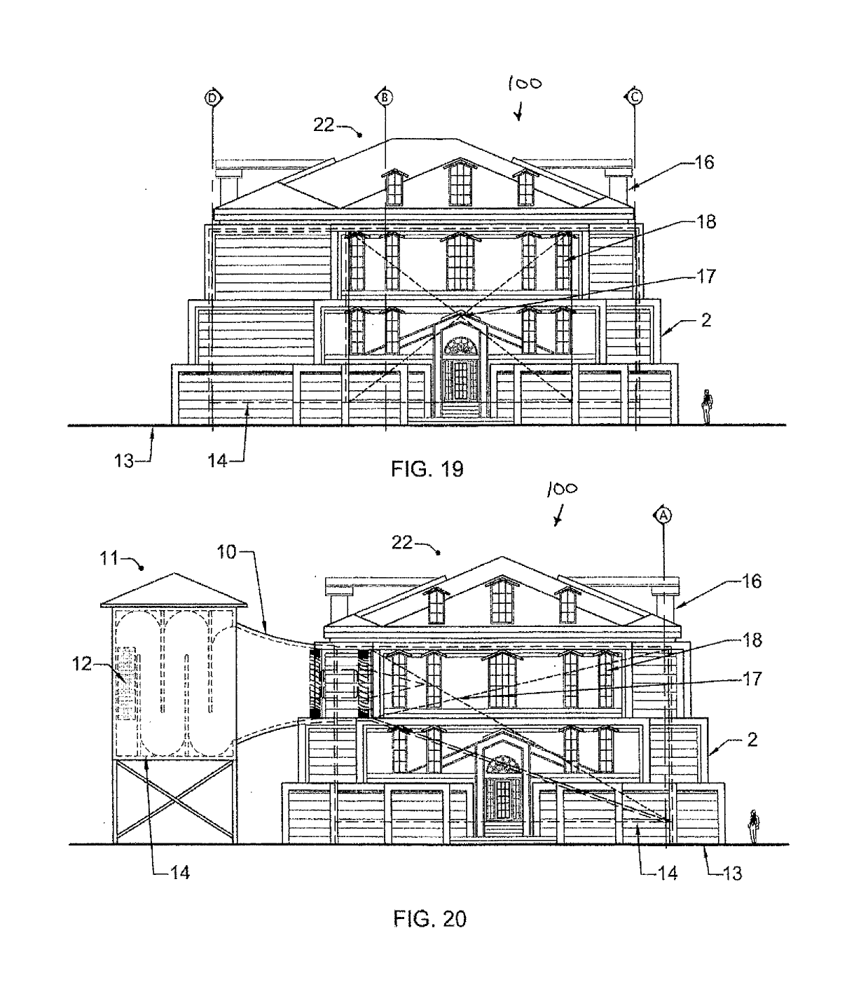

FIG. 19 is the front elevation of the retractable multiple direction wind funnel system 22 showing the wind intake aperture 17 and other components as indicated.

FIG. 20 is the left side elevation of the retractable multiple direction wind funnel system 22 showing the wind intake aperture 17 and other components as indicated.

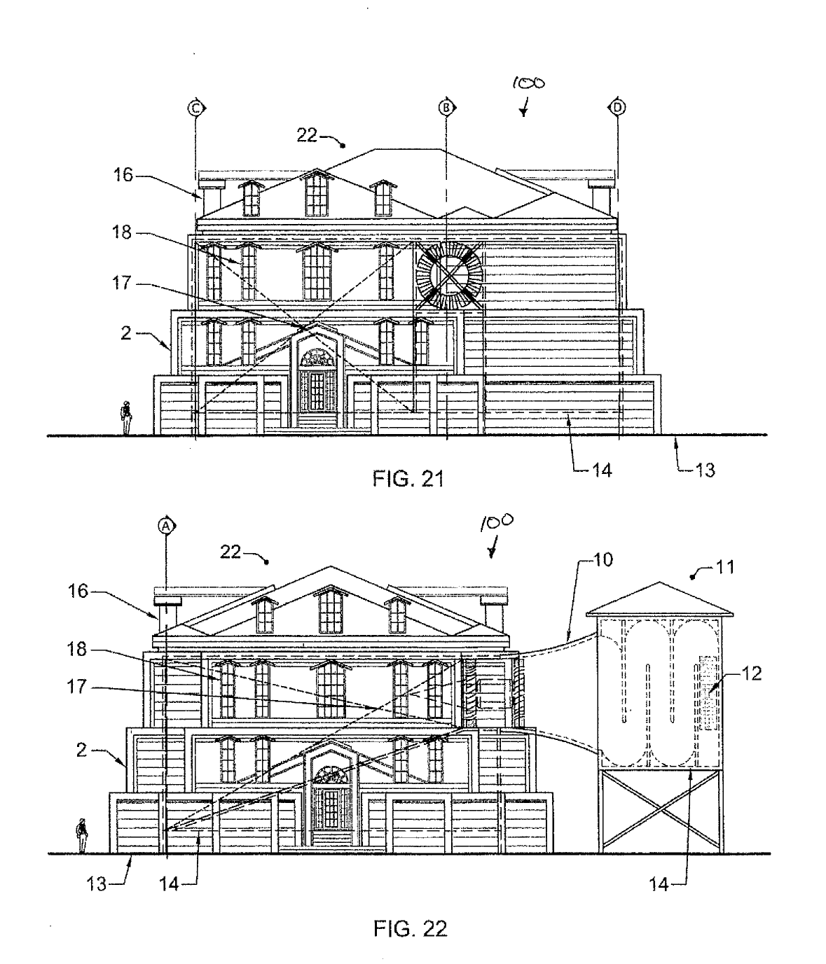

FIG. 21 is the back elevation of the retractable multiple direction wind funnel system 22 showing the wind intake aperture 17 and other components as indicated.

FIG. 22 is the right side elevation of the retractable multiple direction wind funnel system 22 showing the wind intake aperture 17 and other components as indicated.

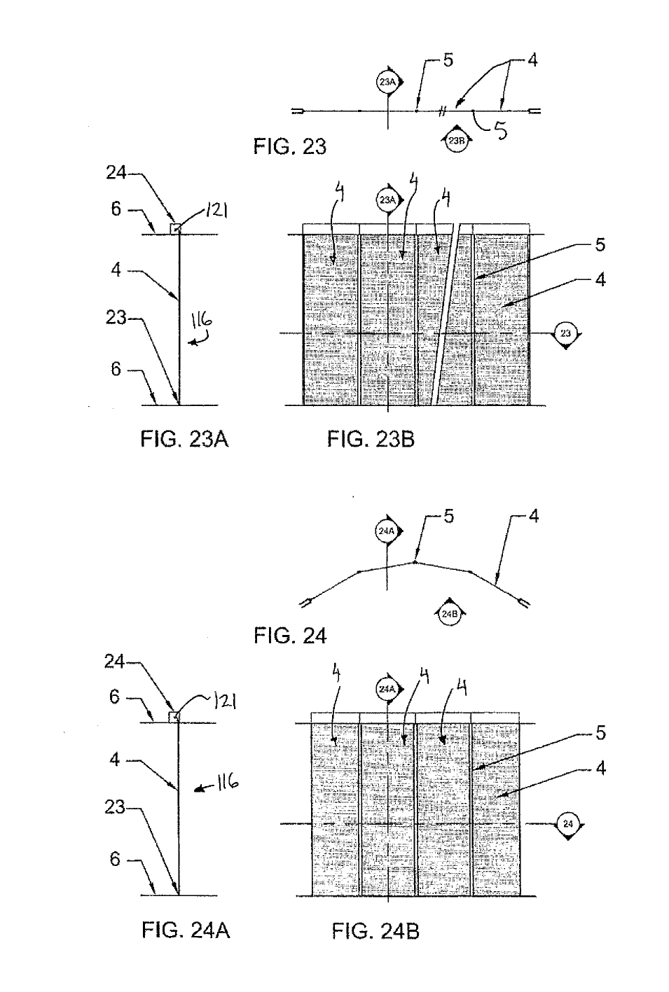

FIG. 23 is a plan of retractable partitions 4 which are arranged to form a straight segment.

FIG. 23A is a section through the retractable partitions 4 as per FIG. 23.

FIG. 23B is an elevation of retractable partitions 4 as per FIG. 23.

FIG. 24 is a plan of retractable partitions 4 which are arranged to form a curved segment.

FIG. 24A is a section of retractable partitions 4 as per FIG. 24.

FIG. 24B is an elevation of retractable partitions 4 as per FIG. 24.

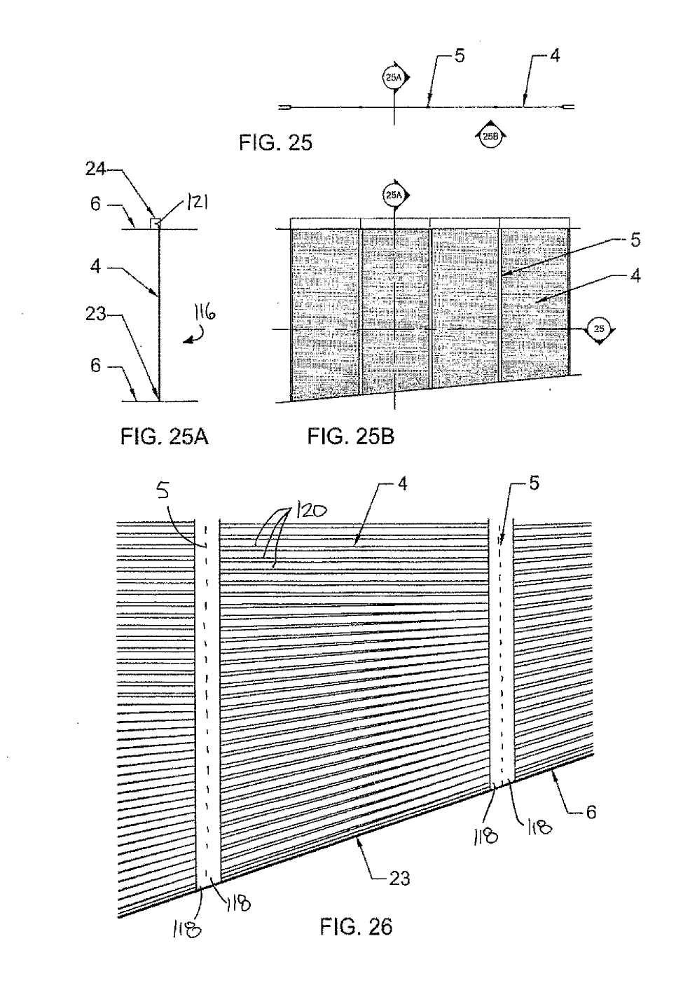

FIG. 25 is a plan of retractable partitions 4 for a sloping floor area of the wind funnel 6.

FIG. 25A is a section through the retractable partitions 4 as per FIG. 25.

FIG. 25B is an elevation of retractable partitions 4 as per FIG. 25.

FIG. 26 is an elevation detail of a retractable partition 4 as it adapts to a sloping floor area of the wind funnel 6. The metal slats of the retractable partitions 4 are fastened to wind proof fabric on one side with evenly spaced gaps between them. When deployed to meet the sloping floor of the wind funnel 6 the space between the metal slats is greater at one side. In this way the retractable partitions 4 can adapt to a sloping floor area of the wind funnel 6 and form an airtight seal in conjunction with its rubber coated metal base 23.

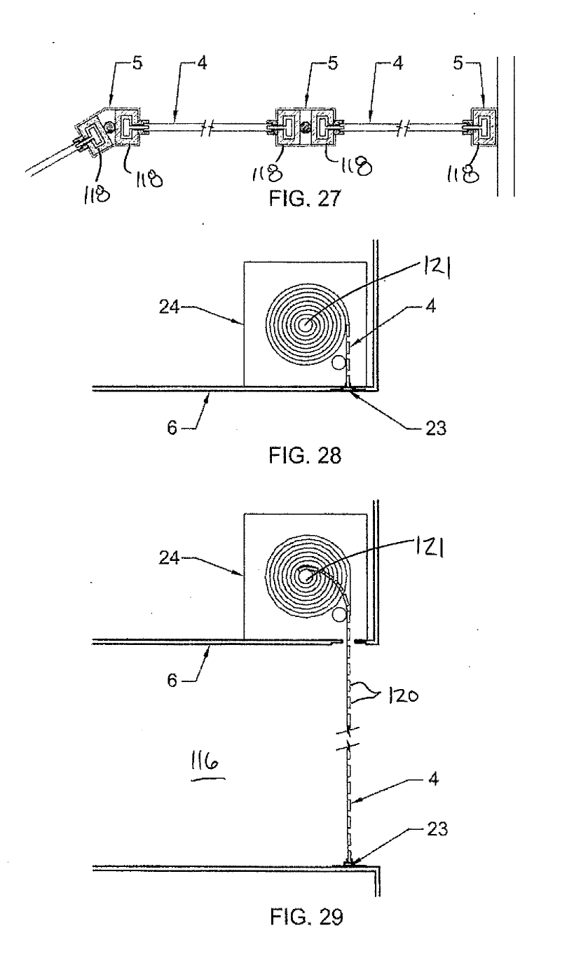

FIG. 27 is a plan detail of the cables and guides 5 of the retractable partitions 4 showing a straight and curved segment.

FIG. 28 is a section detail through the top of a retractable partition 4 in the retracted position. When the retractable partition 4 is in retracted position it is countersunk into the ceiling of the wind funnel 6 in a recessed trough 24 where its rubber coated metal base 23 pockets smoothly into the ceiling of the wind funnel 6.

FIG. 29 is a section detail of the retractable partition 4 in the deployed position illustrating its rubber coated metal base 23 forming an airtight seal with the rubber coated floor of the wind funnel 6.

FIG. 30 is the plan of the retractable multiple direction wind funnel system 22 where the activated front wind funnel 6 connects to the turbine and generator 7, 8 shroud 10 and piezoelectric oscillators module 27. Within the piezoelectric oscillators module 27 are piezoelectric oscillator blades 26 which are made of metal or other high tensile material approximately 18″×6″×30′ high but may vary according to circumstances and which contain piezoelectric material that compresses when the piezoelectric oscillator blades 26 are oscillated and bent creating electricity by the piezoelectric effect. The piezoelectric oscillator blades 26 located within the piezoelectric oscillators module 27 also act as sound attenuation. This figure is also representative for the three other wind funnel 6 arrangements.

FIG. 30A is a sub-component of the piezoelectric oscillators module 27 which allows the piezoelectric oscillators 26 a full range of motion without being hampered by incoming wind. A rotating aperture disk 25 located at the end of the shroud 10 and the entrance to the piezoelectric oscillators module 27 has rotor blades which turn by the action of wind, an electrical motor, or a pneumatic air system. This rotating aperture disk 25 has two openings which when aligned with duplicate openings at the front of the piezoelectric oscillators module 27 will flow wind intermittently into the piezoelectric oscillators module 27 so the piezoelectric oscillator blades 26 oscillate freely.

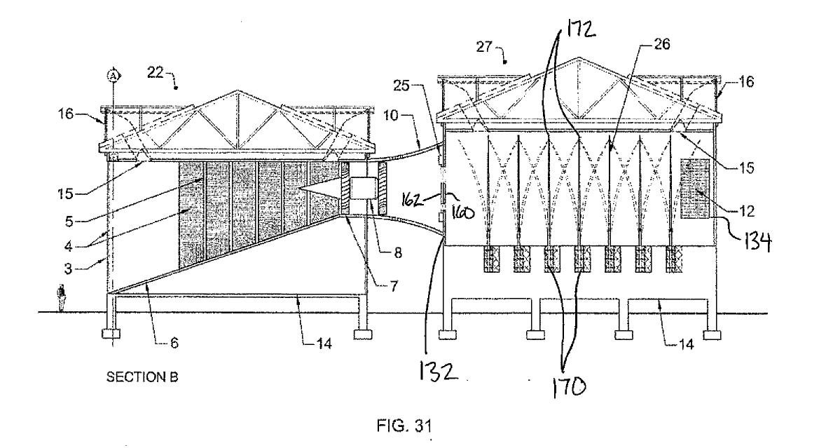

FIG. 31 is a longitudinal section through the retractable multiple directional wind funnel system 22 as per FIG. 30.

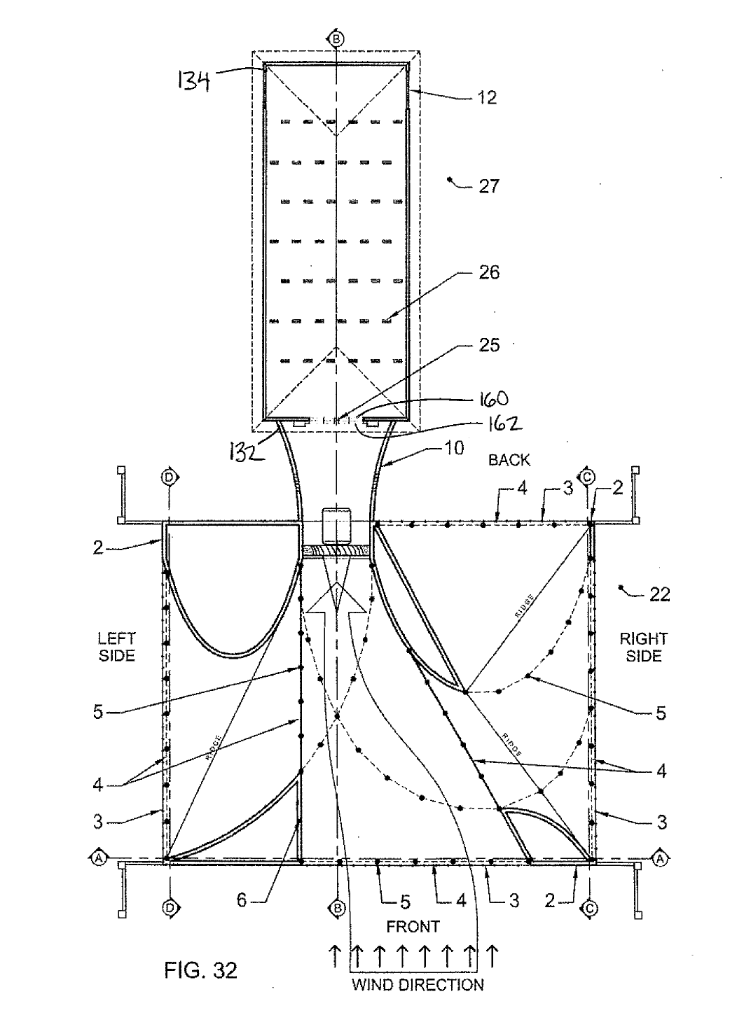

FIG. 32 is the plan of the retractable multiple direction wind funnel system 22 where the wind flows directly through the shroud 10 and into the piezoelectric oscillators module 27 to generate electricity without using a turbine and generator. This figure is also representative for the three other wind funnel 6 arrangements.

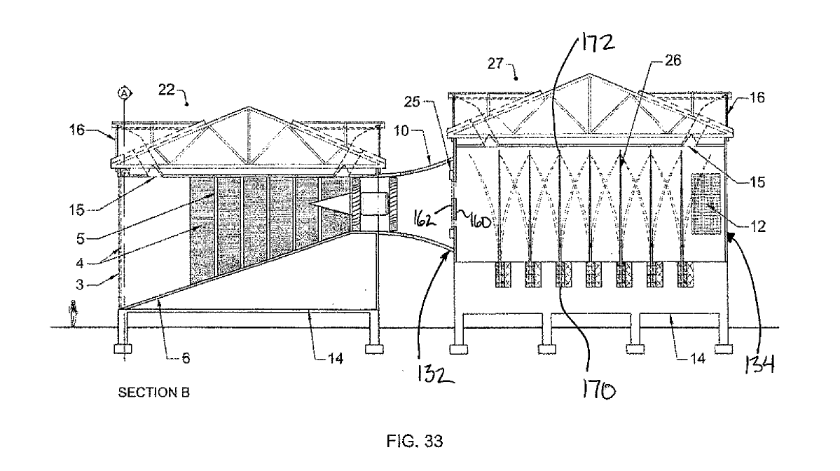

FIG. 33 is a longitudinal section through the retractable multiple direction wind funnel system 22 as per FIG. 32.

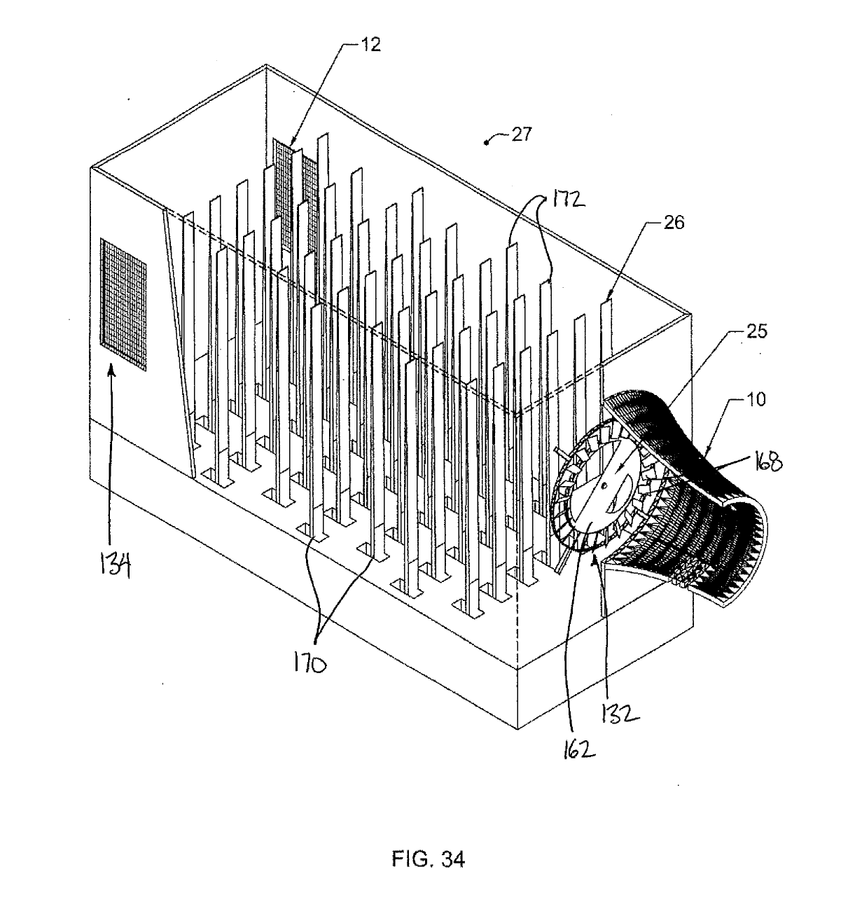

FIG. 34 is a perspective view of the piezoelectric oscillator module 27. Wind flows through a wind funnel system 1, 22, 28, shroud 10, and rotating aperture disk 25 into the piezoelectric oscillators module 27 and out through wind exit grilles 12. It is notable that due to the large volumes of accelerated wind created by the wind funnels 6 the piezoelectric oscillator blades 26 need not be constructed as tall as in typical open air installations where the oscillator blades need to reach higher up for strong winds in order to be able to function properly.

FIG. 35 is the plan of the fixed multiple direction wind funnel system 28. This system has mostly fixed wind funnel walls 6 and only a few retractable partitions 4 used to direct wind to the turbine and generator 7, 8 and shroud 10. Similar to the retractable multiple direction wind funnel system 22, this system may also have perimeter retractable partitions 4 to protect the invention from wind gusts, pressure release dormers 16 to relieve any over pressure conditions, and an optional secondary turbine rotor 9. The embodiment illustrated has a sound attenuation module 11 after the shroud 10, but it is possible that a piezoelectric oscillators module 27 with or without the use of a turbine and generator 7, 8 could also be used for any of the direction specific activated wind funnels 6. The embodiment illustrated has four wind intake apertures 17 and four corresponding wind funnels 6 which direct wind individually from each of the four directions to the turbine and generator 7, 8 but more wind intake apertures 17 and corresponding wind funnels 6 are also possible. This figure shows the arrangement of the four wind funnels 6 with the front wind funnel 6 in activated position using a few retractable partitions to direct wind 4 to the turbine 7, generator 8, optional secondary turbine rotor 9, shroud 10 and sound attenuation module 11.

FIG. 36 is a longitudinal section through the fixed multiple direction wind funnel system 28 as per FIG. 35.

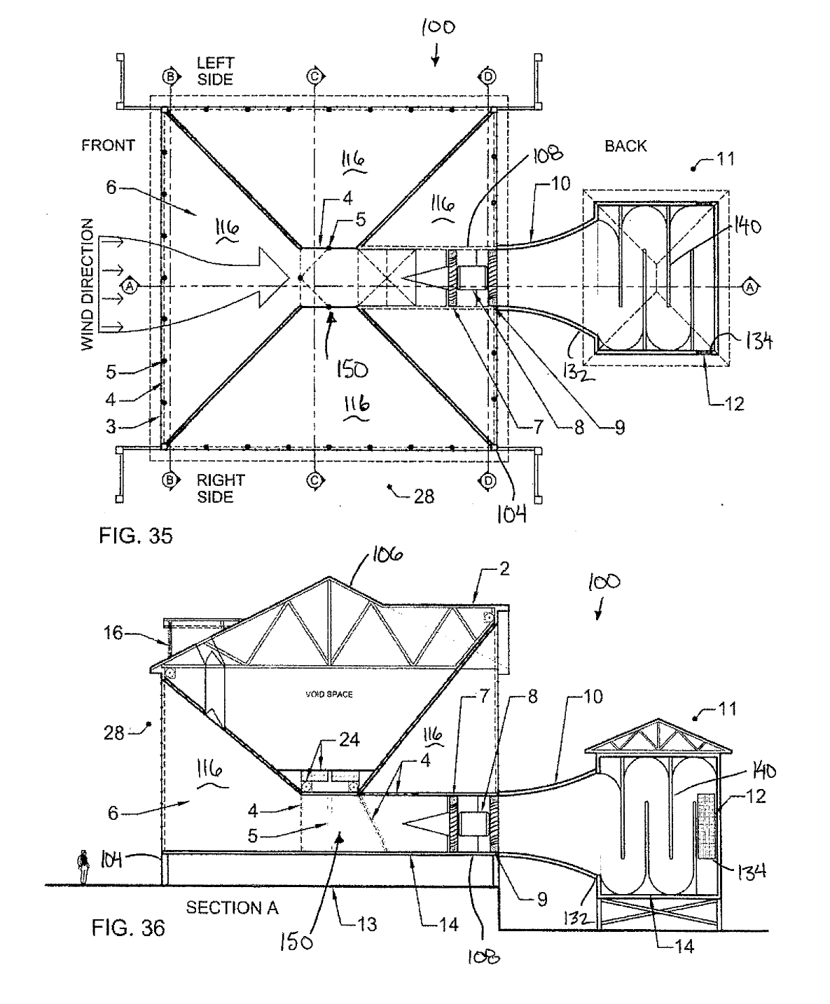

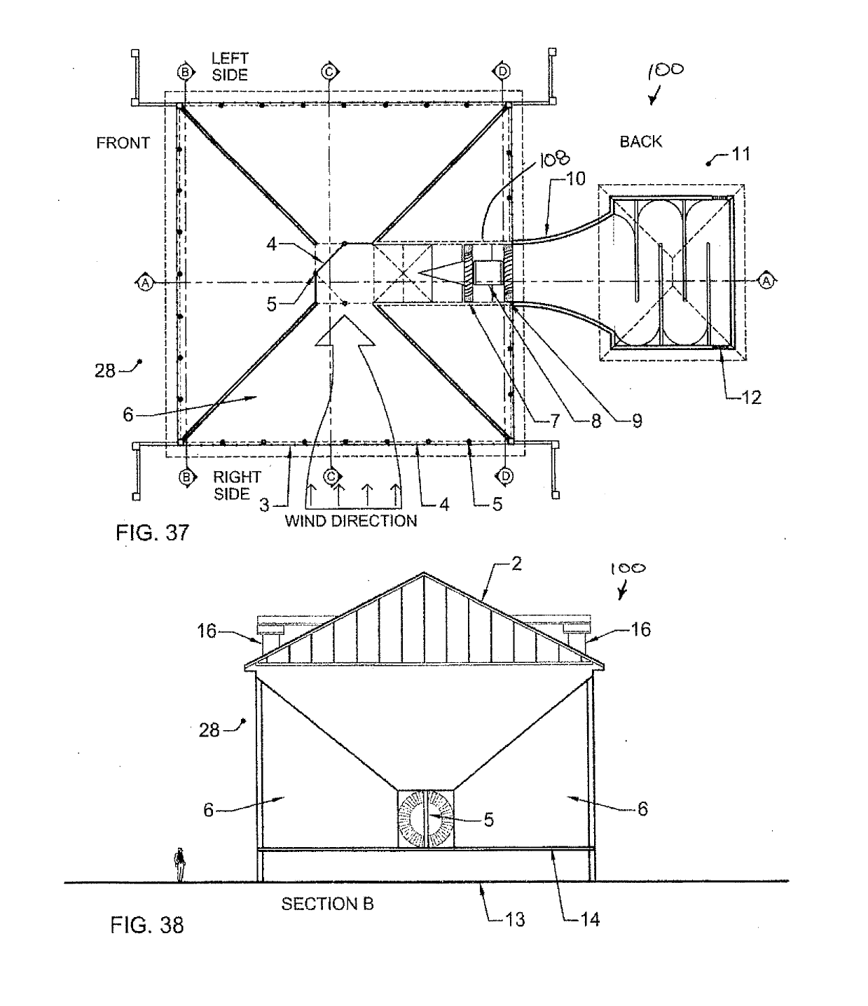

FIG. 37 is the plan of the fixed multiple direction wind funnel system 28 showing the arrangement of the four wind funnels 6 with the right side wind funnel 6 in activated position using a few retractable partitions 4 to direct wind to the turbine 7, generator 8, optional secondary turbine rotor 9, shroud 10 and sound attenuation module 11.

FIG. 38 is a cross section through the fixed multiple direction wind funnel system 28 taken near the entrance to the front wind funnel 6 and looking towards the turbine and generator 7, 8.

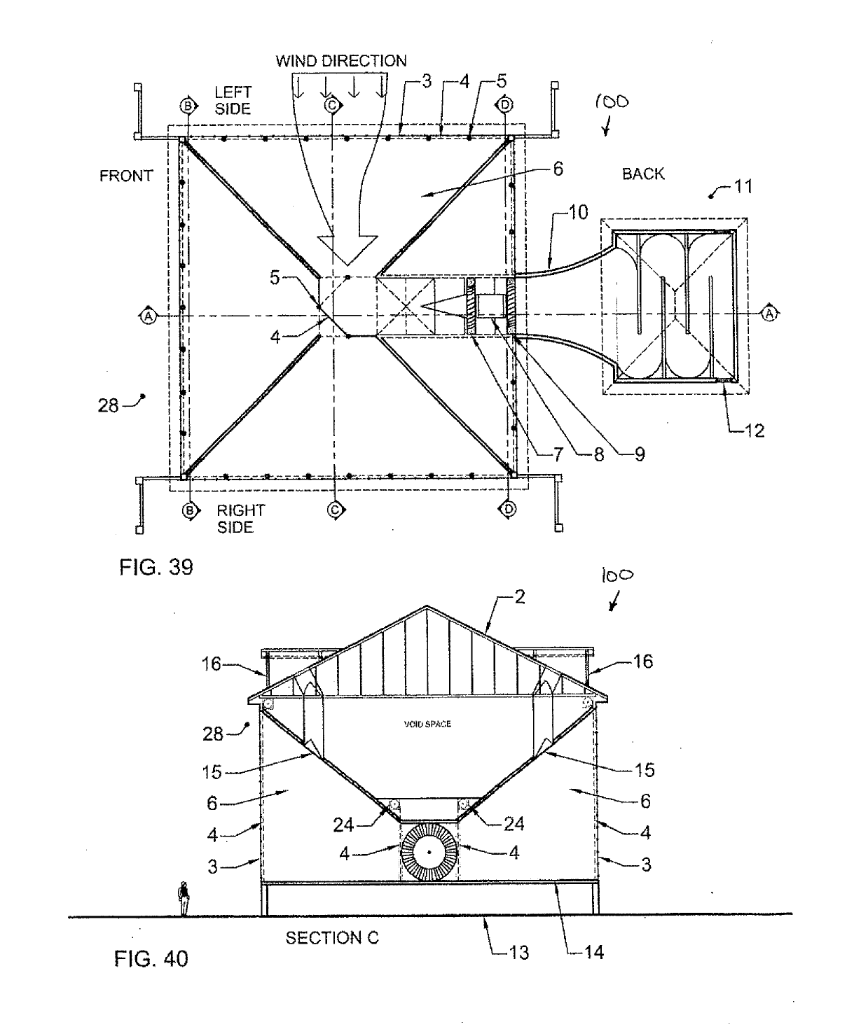

FIG. 39 is the plan of the fixed multiple direction wind funnel system 28 showing the arrangement of the four wind funnels 6 with the left side wind funnel 6 in the activated position using a few retractable partitions 4 to direct wind to the turbine 7, generator 8, secondary turbine rotor 9, shroud 10 and sound attenuation module 11.

FIG. 40 is a cross section through the fixed multiple direction wind funnel system 28 taken where wind from the front, left side, and right side enter a common funnel area leading to the turbine and generator 7, 8.

FIG. 41 is the plan of the fixed multiple direction wind funnel system 28 showing the arrangement of the four wind funnels 6 with the back wind funnel 6 in activated position using a retractable partition 4 mounted on an angle to direct wind coming through a floor opening in the back wind funnel 6 to the turbine 7, generator 8, optional secondary turbine rotor 9, shroud 10 and sound attenuation module 11.

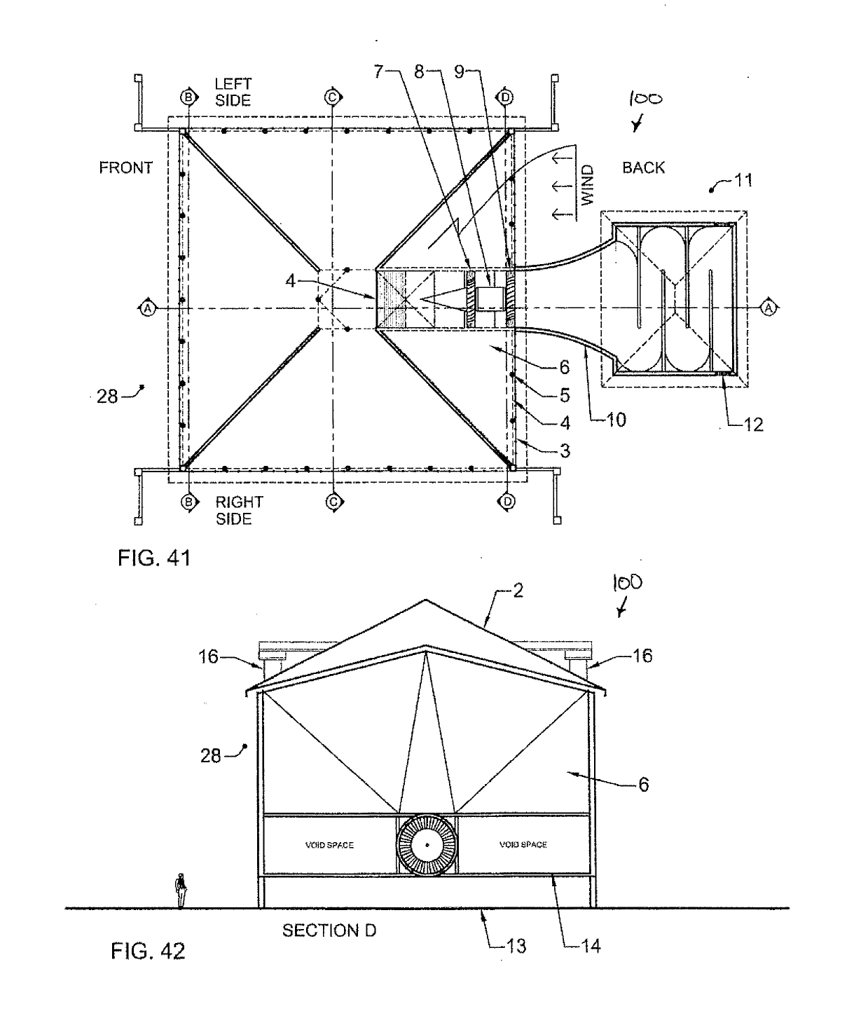

FIG. 42 is a cross section through the fixed multiple direction wind funnel system 28 taken near the entrance to the back wind funnel 6 and looking towards the front.

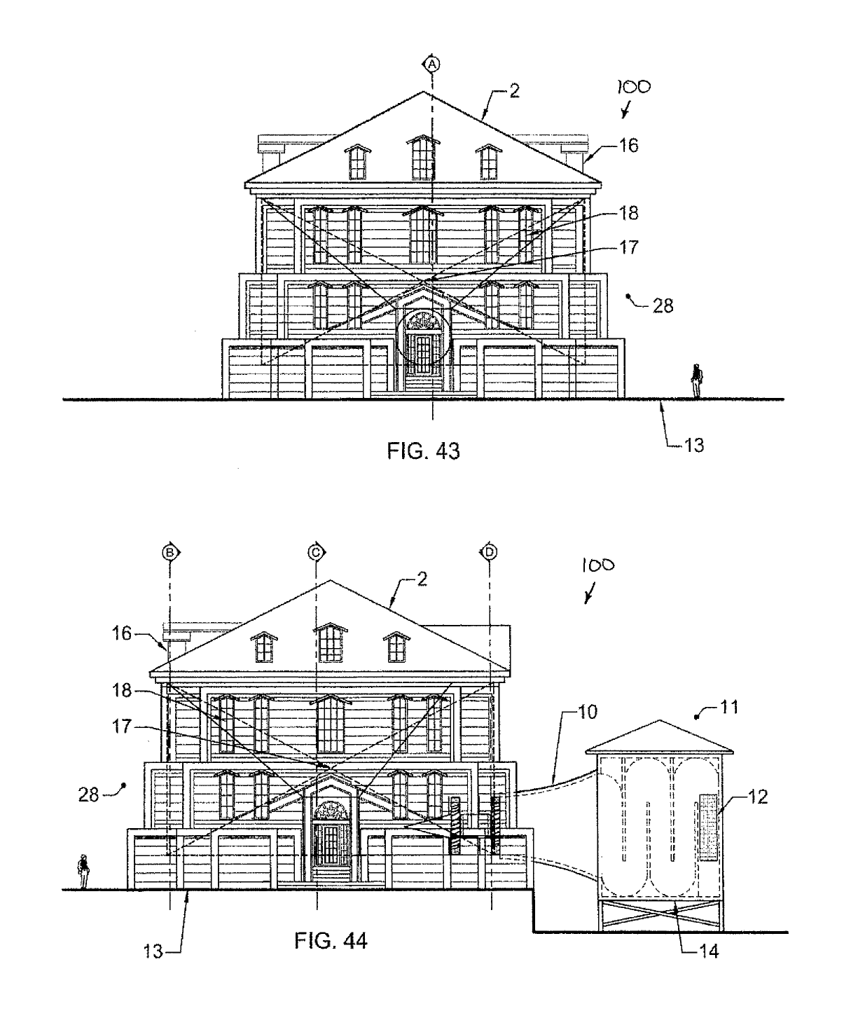

FIG. 43 is the front elevation of the fixed multiple direction wind funnel system 28 showing the wind intake aperture 17 and other components as indicated.

FIG. 44 is the right side elevation of the fixed multiple direction wind funnel system 28 showing the wind intake aperture 17 and other components as indicated.

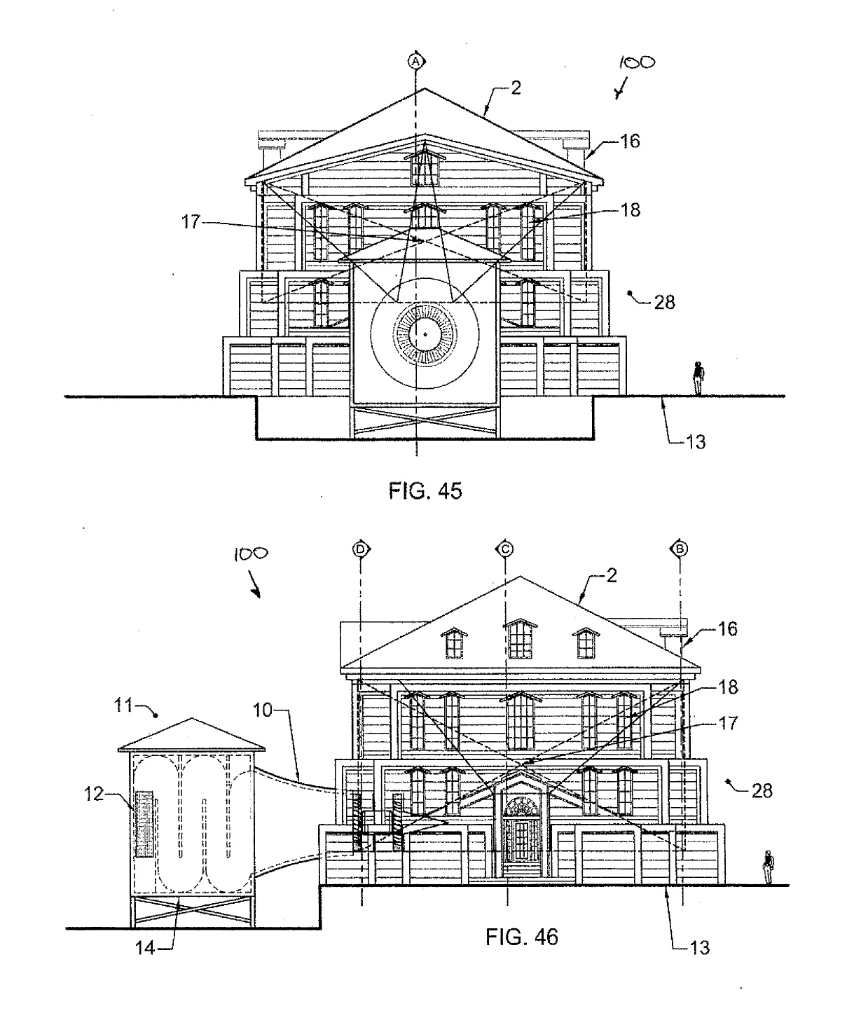

FIG. 45 is the back elevation of the fixed multiple direction wind funnel system 28 showing the wind intake aperture 17 and other components as indicated.

FIG. 46 is the left side elevation of the fixed multiple direction wind funnel system 28 showing the wind intake aperture 17 and other components as indicated.

FIG. 47 is a longitudinal section through a float on water simulating the appearance of a yacht 29 which carries a wind funnel system 1, 22, 28. The intent of this embodiment is to capture wind energy from the surface of water on a lake or at sea either along the coastline or further offshore where greater winds may be present. This figure also illustrates a unique stabilizing anchoring system so that the float 29 remains stable on the water, particularly at sea. A number of anchoring cables 31 are connected to the float 29 where each anchoring cable 31 has an intermediate ballast 32 fastened along the length of the anchoring cable 31, and an anchor ballast 33. While the anchoring cables 31 secure the float from the horizontal movements of water, the intermediate ballasts 32 allow the floats 29 to rise and drop and to thus adapt to the vertical movements of water, similar in motion to an opening and closing arm. While the lengths of the anchoring cables 31 are variable depending on the depth of the water, and the number of anchoring cables 31 with intermediate ballasts 32 are also variable depending on the specific instances, it is the opening arm motion made possible by the intermediate ballast 32 that is of primary importance. This flexible anchoring method allows both small and large floats simulating the appearance of yachts and carrying wind funnel systems 29 to be anchored on water, particularly at sea, and have the ability to remain stable.

FIG. 48 is the plan of the float 29 as per FIG. 47 illustrating the system of anchoring cables 31, intermediate ballasts 32, and anchor ballasts 33.

An additional aspect of the Wind House Energy System is the creation of a new electric grid called a “Green Energy Grid” or which may have another name. This new electric grid is formed by the use of a dedicated transmission line on the existing electric grid to be used only by green energy producing installations such as the Wind House Energy System. The electricity generated by a network of these green energy producing installations would be directly inputted to this grid thereby minimizing the need for any on-site storage of generated electricity. Over a diversity of many green energy producing installations across a range of locations this grid will remain constantly energized wherein favorable energy producing conditions in one locale will compensate for unfavorable conditions in another locale. To help meet the energy needs of various locations during their peak electrical demand times, energy from this parallel and concurrent grid can be drawn upon to meet these energy needs where and when this energy is needed the most. Beyond handling any need for on-site electrical storage the “Green Energy Grid” will supplement and become a type of backup component for the operation of the existing grid.

The following features of the present invention are believed to be distinguished:

An apparatus that is the combination of a wind funnel connected to a turbine and generator and shroud as illustrated in FIGS. 1-9, 11-14, 16, 17, 18, 30, 31, 35, 36, 37, 39, 41, 47, and 48.

An apparatus as above which resembles the appearance of a house, barn, or other building form that can aesthetically integrate with the architecture of its surroundings as illustrated in FIGS. 6-9, 19-22, and 43-46.

An apparatus that is the combination of a wind funnel connected to a turbine and generator, a secondary turbine rotor, shroud, and a sound attenuation module as illustrated in FIGS. 1, 2, 5, 11-14, 16, 17, 18, 35, 36, 37, 39, 41.

An apparatus which resembles the appearance of a house, barn, or other building form that can aesthetically integrate with the architecture of its surroundings as illustrated in FIGS. 6-9, 19-22, and 43-46.

An apparatus that is a curved wind funnel system which can intake wind from four directions or more and which turns in all directions to capture and accelerate wind to a turbine and generator as illustrated in FIGS. 11-14.

An apparatus that is able to receive wind from any four directions or more individually without turning the structure achieved by the specific arrangements of airtight partitions which define separate wind funnels as illustrated in FIGS. 11-18, 30-31, and 35-42. In the preferred embodiments the wind funnels are described and illustrated as having a rectangular cross section along their length. Although this aspect may be common in the preferred embodiments, the features of the present invention are also believed to be distinguished with respect to an apparatus as described above for a wind funnel system with a cross sectional area of any cross sectional shape including curved cross sectional shapes.

An apparatus that is a raised platform for a wind funnel system which allows such systems to be set to an appropriate height to receive favourable winds as illustrated in FIGS. 2, 3, 4, 6-9, 15-22, 31, 33, 36, 38, 40, and 42-46.

A system to elevate the invention on flat land using the combination of long structural piles on undisturbed firm bearing and relocated earth infill to create a new elevated grade without needing to compact the fill material as illustrated in FIG. 10.

An apparatus that is a bird screen that simulates the detail elements of a building, house, or other building form using affixed elements of wrought iron, plastic, or other material which may be designed to aesthetically integrate with the local environment as illustrated in FIGS. 1, 2, 6, 7, 9, 11-14, 16, 17, 19-22, 30-33, 35, 36, 37, 39, 40, 41, and 43-46. In the preferred embodiments the wind funnel systems are described and illustrated as being in the form of a building simulating the appearance of a house, barn or other building form to aesthetically integrate with the local environment. Though this is the preferred embodiment, in other embodiments, the features of the present invention may be used for utilitarian purposes only, without disguising the structure for aesthetic considerations.

An apparatus which is a retractable partition composed of airtight fabric and horizontal slats made of metal or other high tensile material affixed to the airtight fabric with regular spacing between the slats and that unrolls into a deployed position between tensioned cables with guides, and which provides a shock absorbing structural element for protection from wind gusts as illustrated in FIGS. 23, 24, 25, 26, 27, and 28.

An apparatus that is the cable and guides assembly for the retractable partitions in conjunction with the retractable partition structure described above and as illustrated in FIG. 27.

An apparatus that operates the retractable partitions by electric motors or a pneumatic air system.

An apparatus that is the arrangement of the airtight retractable partitions in conjunction with fixed elements of a floor, walls, and ceiling to form wind funnels which capture and accelerate wind to a turbine and generator as illustrated in FIGS. 11-18, 30-33, 35, 36, 37, 39, 40, and 41.

An apparatus that is a retractable partition which is able to follow a sloping floor by horizontal slats which are affixed to the airtight fabric being progressively more open on one side than the other as illustrated in FIGS. 25B and 26.

An apparatus that includes the arrangement of the retractable partitions and track guides to form a curve as illustrated in FIGS. 24 and 27.

An apparatus that is a retractable partition that has a rubber coated metal bar at the base which creates an airtight seal with the floor of the wind funnel as illustrated in FIG. 29.

An apparatus that is a retractable partition which has an airtight connection to its track guides when deployed. A Teflon coated magnetized rubber sleeve is fastened to each side of the track guide in conjunction with similarly magnetized metal slat edges to create an airtight seal with the track guides. The track guides may be heat traced so the metal slats with their sliding key holders can easily slide in the track in cold weather as illustrated in FIG. 27.

An apparatus that includes a pressure release dormer on the exterior of a wind funnel building with a related door in the ceiling of the wind funnel activated by wind pressure or by electronic sensors and motors to open and release over pressure conditions in a wind funnel and which close back automatically as illustrated in FIGS. 2-9, 15-22, 31, 33, 36, 38, 40, 42, and 43-47.

An apparatus that is a module in the form of a building resembling the appearance of a house, barn, or other building form which contains a sound attenuation system as illustrated in FIGS. 1, 2, 5, 7, 9, 11-14, 16, 17, 18, 20, 22, 35, 36, 37, 39, 41, 44, and 46.

An apparatus that is the combination of a wind funnel, turbine and generator, shroud, and a piezoelectric oscillators module as illustrated in FIGS. 30 and 31.

An apparatus that is the combination of wind funnel, shroud, and piezoelectric oscillators module as illustrated in FIGS. 32 and 33.

An apparatus that is a rotating aperture disk which controls the flow of wind into a piezoelectric oscillators module so that wind flows intermittently and allows free motion of the piezoelectric oscillator blades as illustrated in FIGS. 30, 30A, 31, 32, 33, and 34.

An apparatus that includes piezoelectric oscillator blades with their connection between shock absorbers to a concrete foundation within an enclosed structure having wind exit grilles as illustrated in FIGS. 30-34.

An apparatus which is a wind energy system composed primarily of fixed in place wind funnels that capture wind singularly from four or more directions and direct wind to a turbine and generator using only a few retractable partitions to separate the wind funnels from each other as illustrated in FIGS. 35-46.

An apparatus that is a wind funnel system generating electricity installed on a float on water as illustrated in FIGS. 47 and 48.

An apparatus that is a wind funnel system generating electricity installed on a float on water simulating the appearance of a yacht as illustrated in FIGS. 47 and 48. In the preferred embodiments the wind funnel system installed on a float simulates the appearance of a yacht to aesthetically integrate with the local environment. Though this is the preferred embodiment, another embodiment may take the form of a wind funnel system generating electricity installed on a float but where aesthetic considerations are not used and the invention is practised without decoration and only for utility.

An apparatus that stabilizes a float on water and particularly at sea by a system of anchoring cables each having an intermediate ballast fastened between the float and the anchor ballast. This arrangement allows the intermediate ballasts to climb and the anchoring cables to extend when the water levels rises and vice versa thus allowing the float to adapt to changing water levels in a stable fashion as illustrated in FIGS. 47 and 48.

An apparatus that is a wind funnel system installed on a float on water that simulates the appearance of a yacht and generates electricity and where a system of cables and ballasts controls the stability of the float as illustrated in FIGS. 47 and 48.

An apparatus that is a wind exit module positioned after the shroud in the form of a box with wind exit grilles at each side and which protects the shroud from wind gusts as illustrated in FIGS. 47 and 48.

An apparatus that is the sloping floors of a wind funnel which allows for the drainage of rainwater or snow melt through the air intake aperture thereby eliminating the need for floor drains which could otherwise reduce wind speed as illustrated in FIGS. 2, 15-18, 31, and 33.

An apparatus that maintains the mobility of moving components such as the retractable partitions and pressure release dormer shutters in cold climates by heating these items through electric heat tracing or infrared lights.

An apparatus that stabilizes the wind funnel operation from minor fluctuations in the minimum required wind intake speed of between five to ten kilometres per hour by modulating the wind intake aperture size by adjusting the degree of openness of the retractable partitions at the wind intake aperture for optimal performance and which can be monitored and activated by sensors and powered by electric motors or a pneumatic air system.

An apparatus that is a wind energy device which produces electricity in the range of three to six megawatts and more and which can operate using low minimum wind speeds of between five to ten kilometres per hour as illustrated in FIGS. 1, 2, 3, 11-18, 30-33, 35-42, 47 and 48.

An apparatus which is a wind energy system that requires only minimal storage of electricity due to its ability to function at low minimum wind speeds of between five to ten kilometers per hour which is available in many locations for long spans of time, and its ability to greatly magnify these winds to produce electricity in the range of three to six megawatts and more using the combination of a large wind funnel, turbine and generator, and shroud as illustrated in FIGS. 1, 2, 3, 11-18, 30-33, 35-42, 47 and 48.

A system which is an energy storage grid called a “Green Energy Grid” or which may have another name which is created by using a dedicated transmission line on the existing grid which connects a network of green energy producing installations such as the present invention in various locations. This “Green Energy Grid” will achieve constant energization by having a diverse network of many green energy producing installations over a wide range of locations to ensure sufficient backup capacity. The need for on-site storage of energy produced can then be minimized as electricity generated can be input directly to this grid which will then act as a storage system from which electricity can be drawn into the main electric grid where and when it is most needed, particularly for peak demand times across various locations.

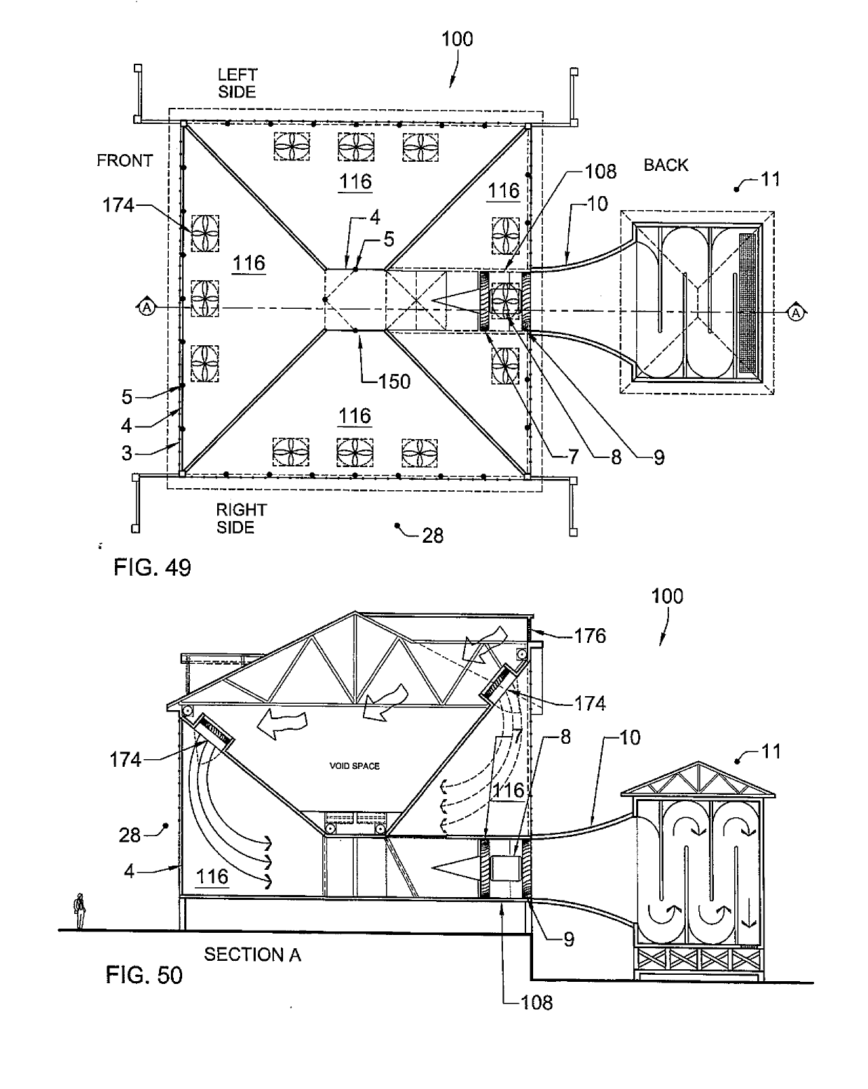

Turning now to FIGS. 49 and 50, a further embodiment of the system will now be described. FIG. 49 illustrates an auxiliary backup system for ongoing electricity production when outside winds are insufficient. A suitable flywheel mass is driven to rotate together with the turbine to maintain some rotational momentum even when there is a low air flow condition. A sensor in the turbine duct is arranged to sense a low air flow condition when the airflow through the duct is below a minimum threshold.

In this instance, the system uses an internal set of fans 174 near the start of a closed funnel to deliver accelerated air through the funnel to the turbine. More particularly, a plurality of auxiliary supply fans 174 communicate through the upper boundary wall of each inlet duct proximate to the inlet openings of the inlet ducts to supply a flow of auxiliary air into one or more selected inlet ducts when there is determined to be insufficient wind.

When the housing is in the form of a building, an overhead attic space is enclosed below the roof of the housing and above all of the upper boundary walls of the inlet ducts. An air intake vent 176 communicates through a wall of the attic space between the enclosed overhead space and an exterior to allow ambient air to enter the attic space therethrough. The attic space communicates directly with an inlet side of each of the auxiliary supply fans 174 so that the fans drive air flow from the exterior into the attic space, and from the attic space into the respective inlet ducts.

The retractable boundary wall partitions 4 operatively associated with the inlet opening of each inlet duct function as respective gates which are operable between an open position in which the inlet opening is substantially unobstructed by the gate and a closed position in which the inlet opening is closed by the gate.

The gates are all closed and the auxiliary supply fans 174 of the selected one or more inlet ducts are operated responsive to determination of the low air flow condition by the air flow sensors. Each auxiliary supply fan is driven to rotate using an electrical motor operatively connected to receive electrical power from the electrical generator 8 connected to the turbine.

The sequence of operation for the auxiliary backup system comprises the following steps:

1. Sensors detecting overall diminishing wind speed to a prescribed extent will trigger the activation of the auxiliary backup system while the turbine rotor is still rotating and well in advance of the turbine rotor stopping completely.

2. The triggering of the auxiliary backup system will activate the closing of one of the funnel inlets by having the retractable partitions of the wind intake aperture deploy to seal the funnel.

3. After the funnel inlet is closed, air is blown through the funnel to the turbine by a set of fans mounted in the roof of the funnel which take in air through a roof vent in the body of the main housing. By the nature of the funnel shape, the air that is pumped though the funnel by the fans will be accelerated along its path to the turbine by the funnel's decreasing cross sectional area which will act to increase its speed and power.

The turbine rotor in this instance functions as a flywheel and stores rotational energy through momentum over a period of time. For the turbine rotor to function as a flywheel the blades of the rotor will be weighted and low friction bearings will be used. Once the initial inertia of turbine rotation is overcome and the turbine is in active rotation the rotor flywheel will accumulate a store of energy through momentum thereby providing the capacity to extract at short intervals the necessary additional energy to energize the fans.

The auxiliary backup system therefore comprises an ongoing series of intermittent boosts to the turbine by air pushed by a set of fans and accelerated through one or more of the funnels to the turbine. The fans are energized by intermittently extracting a portion of the energy stored by the turbine rotor flywheel which then in turn pushes air accelerated through the funnel to again boost the turbine rotor flywheel. The turbine will tend to continue to produce electricity for short periods until sufficient winds become available for outside wind powered funnel turbine operation to resume.

The portion of accelerated air which is normally used for CO₂ extraction, when in the event of low wind conditions, can be re-allocated to power the backup system fans. in this case the air flowing through the sound attenuation module with CO₂ extraction would be

Preferably each funnel will be equipped with its own set of fans mounted near the top of the boundary wall inlet duct so that in the event of maintenance while the system is activated an alternate funnel and fan set can be used and the system can remain active.

FIG. 49 illustrates the front wind funnel arranged as the active funnel for the auxiliary backup system with its intake aperture closed by having its retractable partitions deployed and with the other retractable partitions deployed to form a funnel to the turbine.

FIG. 50 illustrates the section of the turbine backup system as per FIG. 49 with the front wind funnel arranged as the active funnel for the auxiliary backup system with its inlet retractable partitions deployed and other retractable partitions deployed to form a funnel to the turbine. The fans mounted in the ceiling of the funnels are shown (174) in conjunction with the roof vent air intake for the fans (176).

Since various modifications can be made in my invention as herein above described, and many apparently widely different embodiments of same made, it is intended that all matter contained in the accompanying specification shall be interpreted as illustrative only and not in a limiting sense.

1. A wind turbine assembly comprising:
a main housing including a plurality of upright wall portions, a roof portion, and at least one inlet opening formed in the upright wall portions;
a wind turbine supported within the housing which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct; and
inlet ducting communicating from said at least one inlet opening to the turbine inlet;
the upright wall portions, the roof portion, and said at least one inlet opening of the housing being configured to visually represent a building.

2. The assembly according to claim 1 wherein the turbine assembly is supported on a foundation substantially at ground level.

3. The assembly according to either one of claim 1 or 2 further comprising a screen spanning across said at least one inlet opening so as to be substantially flush with the respective wall portion.

4. The assembly according to any one of claims 1 through 3 wherein said at one inlet opening comprises a plurality of inlet openings located in respective upright wall portions on different sides of the housing.

5. The assembly according to claim 4 wherein the upright wall portions define a rectangular perimeter of the housing having four sides and wherein there is provided an inlet opening in each of the four sides of the housing.

6. The assembly according to either one of claim 4 or 5 wherein the inlet ducting includes an inlet duct arranged for communication between each inlet opening and the turbine inlet, each inlet duct comprising at least one movable boundary wall partition which is movable between an operable position forming a portion of a boundary of the respective inlet duct which obstructs communication of at least one other inlet duct with the turbine inlet and a stored position in which communication with said at least one other inlet duct is substantially unobstructed by the movable boundary wall partition.

7. The assembly according to any one of claims 4 through 6 further comprising at least one movable boundary wall partition associated with each inlet opening so as to be movable between a closed position spanning across the inlet opening such that the inlet opening is closed and an open position in which the inlet opening is substantially unobstructed by the movable boundary wall partition.

8. The assembly according to claim 7 further comprising a wind sensor arranged to sense wind speed through each inlet opening and a controller arranged to controllably position said at least one movable wall portion of the respective inlet opening in one or more intermediate positions so as to regulate a quantity of wind flow through the respective inlet opening within a prescribed operating range.

9. The assembly according to any one of claims 1 through 8 wherein a bottom boundary wall of all of the inlet ducting is sloped downwardly towards said at least one inlet opening.

10. The assembly according to any one of claims 1 through 9 further comprising a secondary housing separate from the main housing and exhaust ducting communicating from the turbine outlet to the secondary housing.

11. The assembly according to claim 10 further comprising an exhaust duct in the secondary housing which follows a sinuous path from an inlet end in communication with the exhaust ducting to an outlet end which is exhausted externally of the secondary housing.

12. The assembly according to claim 11 wherein the exhaust duct in the secondary housing comprises an absorbing material arranged to absorb carbon dioxide from a flow of exhaust air communicated through the exhaust ducting from the inlet end to the outlet end.

13. The assembly according to any one of claims 10 through 12 further comprising an auxiliary wind energy device supported within the secondary housing.

14. The assembly according to claim 13 wherein the secondary housing includes boundary walls surrounding a hollow interior extending in a longitudinal direction between an inlet at a first end and an outlet at a second end of the housing and wherein the auxiliary wind energy device further comprises:
a valve device cooperative with the inlet of the housing so as to be cyclically operable between an open position permitting a prescribed wind flow through the inlet into the housing and a closed position in which wind flow through the inlet into the housing is at least partially restricted relative to the open position so as to generate an intermittent flow through the housing;
at least one oscillating blade member supported in the hollow interior of the housing so as to extend transversely to the longitudinal direction of the housing between a first end coupled to the housing and a second end which is freely suspended within the hollow interior, said at least one oscillating blade member comprising:
a main body which is flexible in a direction corresponding to the second end of the oscillating blade member being movable generally in the longitudinal direction of the housing such that the main body is arranged to oscillate in response to said intermittent flow; and
piezoelectric material coupled to the main body so as to be subjected to bending stresses of the main body so as to create an electrical current in response to oscillations of the main body.

15. A wind turbine assembly comprising:
a main housing including a plurality of upright wall portions and a plurality of inlet openings located in respective upright wall portions on different sides of the housing;
a wind turbine supported within the housing which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct; and
an inlet duct arranged for communication between each inlet opening and the turbine inlet;
wherein each inlet duct comprises at least one movable boundary wall partition which is movable between an operable position forming a portion of a boundary of the respective inlet duct which obstructs communication of at least one other inlet duct with the turbine inlet and a stored position in which communication of said at least one other inlet duct is substantially unobstructed by the movable boundary wall partition.

16. The assembly according to claim 15 wherein a bottom boundary wall of each inlet duct is sloped downwardly towards the respective inlet opening.

17. The assembly according to either one of claim 15 or 16 wherein the inlet openings are provided in at least two of the upright wall portions of the main housing which are different in orientation from one another so as to span a majority of the boundary wall portion.

18. The assembly according to any one of claims 15 through 17 wherein the upright wall portions of the housing define a polygonal shape having numerous sides and wherein one of the inlet openings is provided in each of the sides of the polygonal shape of the housing so as to span a majority of the respective side.

19. The assembly according to any one of claims 15 through 18 further comprising at least one movable boundary wall partition associated with each inlet opening so as to be movable between a closed position spanning across the inlet opening such that the inlet opening is closed and an open position in which the inlet opening is substantially unobstructed by the movable boundary wall partition.

20. The assembly according to any one of claims 15 through 19 wherein each movable boundary wall partition comprises a flexible member coupled to a roller so as to be arranged to be rolled onto the roller when not in use.

21. The assembly according to claim 20 wherein each roller is supported outside of a boundary of the respective inlet duct such that the flexible member is arranged to be deployed from the roller into the inlet duct through a dispensing slot in a boundary wall of the respective inlet duct.

22. The assembly according to either one of claim 20 or 21 wherein the flexible member comprises a flexible sheet member and a plurality of rigid slats spanning a width of the sheet member spaced apart from one another and substantially parallel to an axis of the respective roller such that the rigid slats are angularly adjustable relative to one another within a plane of the boundary wall partition.

23. The assembly according to any one of claims 20 through 22 further comprising a plurality of structural cables arranged to be supported under tension to span between opposing boundaries of respective inlet ducts so as to support the movable boundary wall partitions respectively when in use.

24. The assembly according to any one of claims 15 through 23 wherein each inlet duct comprises side boundaries in which the majority of the side boundaries are defined by fixed boundary wall partitions.

25. The assembly according to any one of claims 15 through 23 wherein each inlet duct comprises side boundaries in which the majority of the side boundaries are defined by the movable boundary wall partitions.

26. The assembly according to claim 25 wherein a portion of each side boundary of each inlet duct is defined by a plurality of the movable boundary wall partitions in series with one another in which the movable boundary wall partitions are planar in use and angularly offset from adjacent ones of the movable boundary wall partitions such that the side boundary is generally curved.

27. The assembly according to any one of claims 15 through 26 further comprising a pressure relief duct in communication with each inlet duct, each pressure relief duct being arranged to be exhausted externally of the main housing only when a pressure within the inlet duct exceeds an upper pressure relief limit.

28. A wind energy device comprising:
a housing including walls surrounding a hollow interior extending in a longitudinal direction between an inlet at a first end and an outlet at a second end of the housing;
a valve device cooperative with the inlet of the housing so as to be cyclically operable between an open position permitting a prescribed wind flow through in the inlet into the housing and a closed position in which wind flow through the inlet into the housing is at least partially restricted relative to the open position so as to generate an intermittent flow through the housing;
at least one oscillating blade member supported in the hollow interior of the housing so as to extend transversely to the longitudinal direction of the housing between a first end coupled to the housing and a second end which is freely suspended within the hollow interior, said at least one oscillating blade member comprising:
a main body which is flexible in a direction corresponding to the second end of the oscillating blade member being movable generally in the longitudinal direction of the housing such that the main body is arranged to oscillate in respective to said intermittent flow; and
piezoelectric material coupled to the main body so as to be subjected to bending stresses of the main body so as to create an electrical current in response to oscillations of the main body.

29. The device according to claim 28 wherein said at least one oscillating blade member comprises a plurality of oscillating blade members at laterally and longitudinally spaced positions throughout the hollow interior of the housing.

30. The device according to claim 29 wherein the oscillating blade members are arranged in laterally oriented rows which are longitudinally spaced apart, each oscillating blade member being laterally offset relative to the oscillating blade members of adjacent rows.

31. The device according to any one of claims 28 to 30 in combination with a wind turbine comprising a turbine duct communicating from a turbine inlet to a turbine outlet and a turbine rotor which is rotatable within the turbine duct and which is arranged to be driven to rotate in response to a flow of air through the turbine duct, wherein the turbine outlet is operatively connected to the inlet of the housing such that the valve device is in series between the turbine and the housing.

32. The device according to any one of claims 28 through 31 wherein the valve device comprises a fixed member having at least one fixed aperture therein and a rotating member supported for rotation relative to the fixed member and having at least one rotating aperture therein arranged to be cyclically aligned with said at least one fixed aperture as the rotating member is rotated relative to the fixed member.

33. The device according to claim 32 wherein the rotating member includes at least one blade supported therein so as to be arranged to drive rotation of the rotating member in response to a flow of wind therethrough.

34. The device according to either one of claim 32 or 33 wherein said at least one fixed aperture comprises a pair of fixed apertures which are diametrically opposed relative to one another about an axis of the rotating member and said at least one rotating aperture comprises a pair of rotating apertures which are diametrically opposed relative to one another about said axis of the rotating member.

35. A wind turbine assembly comprising:
a buoyant housing arranged to be buoyantly supported on a body of water;
a wind turbine supported on the housing above a surface of the body of water which includes a turbine duct communicating from a turbine inlet to a turbine outlet which is exhausted externally of the housing, and a turbine rotor which is rotatable within the turbine duct and which is arranged to be driven to rotate in response to a flow of air through the turbine duct;
a plurality of anchoring cables, each extending between a first end coupled to the frame and a second end arranged to be coupled to a fixed structure; and
a biasing element coupled to each cable so as to bias the cable away from a first position in which the first and second ends of the cable are at a first prescribed distance relative to one another towards at least one second position in which the first and second ends of the cable are at a second prescribed distance relative to one another which is less than the first prescribed distance.

36. The assembly according to claim 35 wherein the buoyant housing comprises a plurality of upright wall portions and a roof portion which surround the wind turbine and which are configured to resemble a marine vessel.

37. The assembly according to either one of claim 35 or 36 wherein the biasing element comprises a weighted ballast member supported on each cable at an intermediate location spaced inwardly from both of the first and second ends of the respective cable.

38. The assembly according to any one of claims 35 through 37 wherein the cables extend radially outwardly from the buoyant housing at circumferentially spaced apart positions about a full perimeter of the buoyant housing from the first ends to the second ends of the cables.

39. The assembly according to an one of claims 35 through 38 wherein the second ends of the cable are coupled to respective ballast members arranged to be fixed relative to the sea bed of the body of water.

40. An auxiliary electrical grid for use in combination with an existing electrical grid comprised of a network of primary transmission cables communicating from a source to a plurality of users and a plurality of green energy devices arranged to generate electricity without consuming fuel, the auxiliary electrical grid comprising:
a network of auxiliary transmission cables in communication between the green energy devices and the plurality of users in parallel with the existing electrical grid.

41. The auxiliary electrical grid according to claim 40 wherein the green energy devices are the only source of electrical energy supplied to the auxiliary grid.

42. The auxiliary electrical grid according to either one of claim 40 or 41 wherein the auxiliary electrical grid is arranged to provide supplementary electrical power to the existing electrical grid.

43. A wind turbine assembly comprising:
a wind turbine including a turbine duct communicating from a turbine inlet to a turbine outlet, and a turbine rotor which is rotatable within the turbine duct and which is arranged to be driven to rotate in response to a flow of air through the turbine duct;
an inlet duct having boundary walls defining an inlet passage communicating between an inlet opening of the inlet duct arranged to receive a flow of wind therein and the turbine inlet;
an auxiliary supply fan communicating through one of the boundary walls of the inlet duct between the inlet opening and the turbine inlet so as to be arranged to supply an auxiliary flow of air to the inlet duct; and
a gate operable between an open position in which the inlet opening is substantially unobstructed by the gate and a closed position in which the inlet opening is closed by the gate.

44. The assembly according to claim 43 further comprising a sensor arranged to sense a low air flow condition when the airflow through the duct is below a minimum threshold, wherein the gate closes and the auxiliary supply fan operates responsive to determination of a low air flow condition.

45. The assembly according to either one of claim 43 or 44 further comprising an electrical generator driven by the turbine rotor, wherein the auxiliary supply fan is driven to rotate using an electrical motor operatively connected to receive electrical power from the electrical generator.

46. The assembly according to any one of claims 43 through 45 further comprising a flywheel mass driven to rotate together with the turbine.

47. The assembly according to any one of claims 43 through 46 wherein the inlet duct is funnel shaped so as to be reduced in cross section from the inlet opening to the turbine inlet and wherein the auxiliary supply fan communicates with the inlet duct proximate to the inlet opening.
